(19) United States
(12) Patent Application Publication
(10) Pub. No.: US 2025/0264606 A1
(43) Pub. Date: Aug. 21, 2025

(54) RADAR-BASED ANALYTICS

(71) Applicant: The Heil Co., Chattanooga, TN (US)

(72) Inventors: Brian Huston Ham, Huntsville, AL (US); Anthony Romano, Havertown, PA (US); Michael Dean Geary, Toronto (CA); Patrick Stewart Carroll, Chattanooga, TN (US); Stanley L. Maroney, Attalla, AL (US)

(21) Appl. No.: 19/005,494

(22) Filed: Dec. 30, 2024

Related U.S. Application Data
(60) Provisional application No. 63/554,489, filed on Feb. 16, 2024.

(51) Int. Cl. G01S 13/931; B60Q 9/00; B65F 1/14; G01S 13/86; G06V 20/58

(52) U.S. Cl. CPC G01S 13/931; B65F 1/14; G01S 13/867; G06V 20/58; B60Q 9/008; G01S 2013/93271; G01S 2013/93272; G01S 2013/93273; G01S 2013/93275

(57) ABSTRACT

Systems and methods for operating a refuse collection vehicle include detecting, using at least one radar sensor coupled to the refuse collection vehicle, a hazard positioned within a detection distance of the at least one radar sensor; transmitting, from the at least one radar sensor to a computing device, a signal indicating the hazard detected by the at least one radar sensor; and in response to receiving the signal, controlling the refuse collection vehicle to prevent damage to the refuse collection vehicle resulting from contact between the hazard and the refuse collection vehicle.

### CROSS-REFERENCE TO RELATED APPLICATION

This application claims the benefit under 35 U.S.C. § 119(e) of U.S. Patent Application No. 63/554,489, entitled “Radar-Based Analytics,” filed Feb. 16, 2024, which is incorporated herein by reference in its entirety.

### TECHNICAL FIELD

This disclosure relates to systems and methods for performing radar-based analytics based on a radar sensor on a refuse collection vehicle.

### BACKGROUND

Refuse collection vehicles collect solid waste and transport the solid waste to landfills, recycling centers, or treatment facilities. The refuse collection routes driven by refuse collection vehicles can involve hazards that are difficult for the driver of the vehicle to detect, such as overhead objects, potholes in the road, and pedestrians near the vehicle.

### SUMMARY

In an example implementation, a system includes a refuse collection vehicle and at least one radar sensor coupled to a portion of the refuse collection vehicle. The refuse collection vehicle includes a chassis and one or more body components. The at least one radar sensor is configured to detect one or more hazards positioned within a detection distance of the at least one radar sensor.

In an aspect combinable with the example implementation, the one or more hazards positioned within a detection distance of the at least one radar sensor includes one or more objects overlying the refuse collection vehicle.

In another aspect combinable with any of the previous aspects, the refuse collection vehicle includes a cab protector; and the at least one radar sensor is coupled to the cab protector.

In another aspect combinable with any of the previous aspects, the one or more objects overlying the refuse collection vehicle include at least one of a tree branch, a power line, or an overpass.

In another aspect combinable with any of the previous aspects, the detection distance is in a range of 1 foot to 10 feet.

In another aspect combinable with any of the previous aspects, the one or more hazards positioned within a detection distance of the at least one radar sensor include one or more hazards along a surface on which the refuse collection vehicle is positioned.

In another aspect combinable with any of the previous aspects, wherein the refuse collection vehicle includes a front bumper; and the at least one radar sensor is coupled to the front bumper.

In another aspect combinable with any of the previous aspects, the one or more hazards includes a pothole in a road surface.

In another aspect combinable with any of the previous aspects, the detection distance is in a range of 5 feet to 20 feet.

In another aspect combinable with any of the previous aspects, the one or more hazards positioned within a detection distance of the at least one radar sensor include an object in front of the refuse collection vehicle and that could result in a potential overhead collision with the refuse collection vehicle.

In another aspect combinable with any of the previous aspects, the at least one radar sensor includes at least one radar sensor coupled to a cab protector of the refuse collection vehicle.

In another aspect combinable with any of the previous aspects, data generated by the at least one radar sensor can be used to determine whether a clearance height the of object is less than an overall height of the refuse collection vehicle.

In another aspect combinable with any of the previous aspects, the refuse collection vehicle comprises one or more fuel tanks coupled to a roof of the refuse collection vehicle.

In another aspect combinable with any of the previous aspects, the at least one radar sensor is configured to generate a point cloud and process the point cloud to detect the one or more hazards.

In another aspect combinable with any of the previous aspects, the refuse collection vehicle further includes a camera configured to capture image data or video data of the one or more hazards.

In another aspect combinable with any of the previous aspects, the system further includes a computing device, and the at least one radar sensor is configured to transmit, to the computing device, a signal indicating the one or more hazards.

In another aspect combinable with any of the previous aspects, the computing device is an onboard computing device of the refuse collection vehicle.

In another aspect combinable with any of the previous aspects, the computing device is configured to generate a map comprising one or more elements indicating a location of each of the one or more hazards detected by the at least one radar sensor.

In another aspect combinable with any of the previous aspects, the refuse collection vehicle includes a display device within the chassis, and the computing device is configured to display the map on the display device.

In another aspect combinable with any of the previous aspects, the computing device is configured to transmit the map to one or more other computing devices for display.

In another aspect combinable with any of the previous aspects, the computing device is configured to control at least one of the one or more body components based on the location of each of the one or more hazards indicated in the map.

In another aspect combinable with any of the previous aspects, the computing device is configured to control at least one of the one or more body components based on receiving the signal indicating the one or more hazards.

In another aspect combinable with any of the previous aspects, in response to receiving the signal indicating the one or more hazards, the computing device is configured to prevent a lift arm of the refuse collection vehicle from being raised above a threshold height.

In another aspect combinable with any of the previous aspects, the computing device is configured to generate a visual alert or an audible alert based on receiving the signal indicating the one or more hazards.

In another example implementation, a method of operating a refuse collection vehicle includes: detecting, using at least one radar sensor coupled to the refuse collection vehicle, a hazard positioned within a detection distance of the at least one radar sensor; transmitting, from the at least one radar sensor to a computing device, a signal indicating the hazard detected by the at least one radar sensor; and in response to receiving the signal, controlling the refuse collection vehicle to prevent damage to the refuse collection vehicle resulting from contact between the hazard and the refuse collection vehicle.

In an aspect combinable with the example implementation, the hazard includes an object overlying the refuse collection vehicle.

In another aspect combinable with any of the previous aspects, controlling the refuse collection vehicle to prevent damage to the refuse collection vehicle resulting from contact between the hazard and the refuse collection vehicle includes preventing a lift arm of the refuse collection vehicle from being raised above a threshold height.

In another aspect combinable with any of the previous aspects, the hazard includes a hazard along a road surface on which the refuse collection vehicle is positioned.

In another aspect combinable with any of the previous aspects, controlling the refuse collection vehicle to prevent damage to the refuse collection vehicle resulting from contact between the hazard and the refuse collection vehicle includes causing the vehicle to change its position on the road surface to avoid contact with the hazard.

In another aspect combinable with any of the previous aspects, the hazard includes an object in front of the refuse collection vehicle and that could result in a potential overhead collision with the refuse collection vehicle.

In another aspect combinable with any of the previous aspects, detecting the hazard includes detecting, based on data generated by the at least one radar sensor, a clearance height of the object; and determining that the clearance height of the object is less than an overall height of the refuse collection vehicle.

In another aspect combinable with any of the previous aspects, determining the clearance height of the object includes determining, based on data received from the at least one radar sensor, a height of the object relative to a road surface beneath the object.

In another aspect combinable with any of the previous aspects, controlling the refuse collection vehicle to prevent damage to the refuse collection vehicle resulting from contact between the hazard and the refuse collection vehicle includes alerting a driver of the refuse collection vehicle that the clearance height of the object is less than an overall height of the refuse collection vehicle.

In another aspect combinable with any of the previous aspects, detecting, the hazard positioned within the detection distance of the at least one radar sensor includes: generating, by the radar sensor, a point cloud; and processing, by the radar sensor, the point cloud to detect the hazard.

Another aspect combinable with any of the previous aspects includes, in response to receiving the signal, causing a camera coupled to the refuse collection vehicle to capture image data or video data of the hazard.

In another aspect combinable with any of the previous aspects, the computing device is an onboard computing device of the refuse collection vehicle.

Another aspect combinable with any of the previous aspects includes generating a map comprising a map element indicating a location of the hazard detected by the radar sensor.

Another aspect combinable with any of the previous aspects includes displaying the map on a display device within a cab of the refuse collection vehicle.

Another aspect combinable with any of the previous aspects includes transmitting, by the computing device, the map to one or more other computing devices for display.

In another aspect combinable with any of the previous aspects, controlling the refuse collection vehicle to prevent damage to the refuse collection vehicle resulting from contact between the hazard and the refuse collection vehicle comprises controlling the refuse collection vehicle based at least partly on a location of each of one or more hazards indicated in the map.

Another aspect combinable with any of the previous aspects includes in response to receiving the signal, generating a visual alert or an audible alert.

In another example implementation, a system includes a refuse collection vehicle and at least one radar sensor coupled to a portion of the refuse collection vehicle. The refuse collection vehicle includes a chassis including a bed. The at least one radar sensor is configured to detect a roll-off container positioned on the bed of the refuse collection vehicle.

In another aspect combinable with the example implementation, the refuse collection vehicle includes a tarp bracket; and the at least one radar sensor is coupled to the tarp bracket.

In another aspect combinable with any of the previous aspects, the at least one radar sensor is configured to generate a point cloud and process the point cloud to detect whether a roll-off container is positioned on the bed of the refuse collection vehicle.

In another aspect combinable with any of the previous aspects, the refuse collection vehicle further includes a camera configured to capture image data or video data of the roll-off container.

In another aspect combinable with any of the previous aspects, the system further includes a computing device, and the at least one radar sensor is configured to transmit, to the computing device, a signal indicating a roll-off container service event performed by the refuse collection vehicle.

In another aspect combinable with any of the previous aspects, the computing device is configured to store the signal received from the at least one radar sensor together with data related to the roll-off container service event.

In another aspect combinable with any of the previous aspects, the data related to the roll-off container service event includes at least one of an indication of whether the roll-off container service event was a loading event or an unloading event, a weight of the roll-off container, an indication of whether the roll-off container was full or empty, GPS coordinates corresponding to a location of the roll-off container service event, image data of the roll-off container, video data of the roll-off container, or a timestamp corresponding to the time that signal was generated.

In another aspect combinable with any of the previous aspects, the computing device is an onboard computing device of the refuse collection vehicle.

In another aspect combinable with any of the previous aspects, the computing device is configured to generate, based at least partly on the signal, a map comprising one or more elements indicating one or more roll-off container service events performed by the refuse collection vehicle.

In another aspect combinable with any of the previous aspects, the computing device is configured to transmit the map to one or more other computing devices for display.

In another aspect combinable with any of the previous aspects, one or more signals generated by the at least one radar sensor are processed to determine whether the roll-off container positioned on the bed of the refuse collection vehicle is full or empty.

In another aspect combinable with any of the previous aspects, the refuse collection vehicle further includes a hoist configured to be coupled to a roll-off container; and a body sensor configured to detect extension and retraction of the hoist; and one or more signals generated by the body sensor and one or more signals generated by the at least one radar sensor can be used to detect the roll-off container being loaded onto the bed or the roll-off container being unloaded from the bed.

In another aspect combinable with any of the previous aspects, the one or more signals generated by the body sensor and the one or more signals generated by the radar sensor can be used to detect whether the roll-off container positioned on the bed of the refuse collection vehicle is full or empty.

In another aspect combinable with any of the previous aspects, the refuse collection vehicle further includes one or more hydraulic cylinders configured to raise and lower the bed; and a body sensor configured to detect extension and retraction of the one or more hydraulic cylinders; and one or more signals generated by the body sensor can be combined with one or more signals generated by the at least one radar sensor to detect the roll-off container being loaded onto the bed or the roll-off container being unloaded from the bed.

Particular implementations of the subject matter described in this specification can be implemented so as to realize one or more of the following advantages.

For example, the refuse collection vehicle of the present disclosure can reduce the risk of damage to the vehicle by detecting one or more hazards proximate the refuse collection vehicle using one or more radar sensors. In some implementations, the refuse collection vehicle of the present disclosure prevents injury to people proximate the refuse collection vehicle by detecting people proximate the refuse collection vehicle, such as people inside refuse containers to be serviced by the refuse collection vehicle. In some implementations, the refuse collection vehicle of the present disclosure can optimize refuse collection by detecting, monitoring, and tracking one or more operations performed by the vehicle using one or more radar sensors. In some implementations, the radar sensors coupled to the refuse collection vehicle of the present disclosure can improve accuracy of objection detection on or near the refuse collection vehicle compared to other sensors. For example, the one or more radar sensors of the present disclosure do not require line-of-sight visibility in order to detect objects proximate the sensor and, therefore, can still accurately perform object detection during vibrations caused by the vehicle and when exposed to dirty environments.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 depicts an example system for collecting refuse.

FIG. 2 is a side, schematic view of a front-loader refuse collection vehicle.

FIG. 3 is another side, schematic view of the refuse collection vehicle of FIG. 2.

FIG. 4 is a perspective view of a radar sensor of the refuse collection vehicle of FIG. 2.

FIG. 5 depicts one or more settings of the radar sensor of the refuse collection vehicle of FIG. 2.

FIG. 6 is an example map generated based on data received from one or more radar sensors of the refuse collection vehicle of FIG. 2.

FIG. 7 is a schematic illustration of an example control system or controller for a refuse collection vehicle.

FIG. 8 is a schematic view of a vehicle for servicing and transporting roll-off containers.

FIG. 9 is a side, schematic view of the vehicle of FIG. 8.

FIG. 10 is schematic view of a radar sensor of the vehicle of FIG. 8.

FIG. 11 is another side, schematic view of the refuse collection vehicle of FIG. 2.

### DETAILED DESCRIPTION

The refuse collection vehicle of the present disclosure includes one or more radar sensors. The radar sensor(s) of the refuse collection vehicle can be used to detect one or more hazards proximate the refuse collection vehicle.

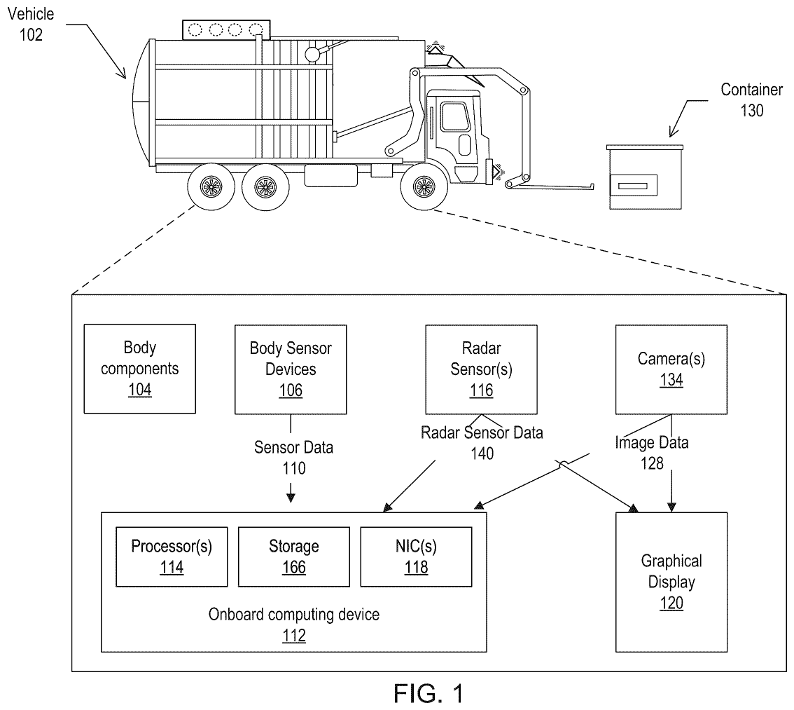

FIG. 1 depicts an example system for collection of refuse. Vehicle 102 is a refuse collection vehicle that operates to collect and transport refuse (e.g., garbage). The refuse collection vehicle 102 can also be described as a garbage collection vehicle, or garbage truck. The vehicle 102 is configured to lift containers 130 that contain refuse, and empty the refuse in the containers into a hopper of the vehicle 102, to enable transport of the refuse to a collection site, compacting of the refuse, and/or other refuse handling activities.

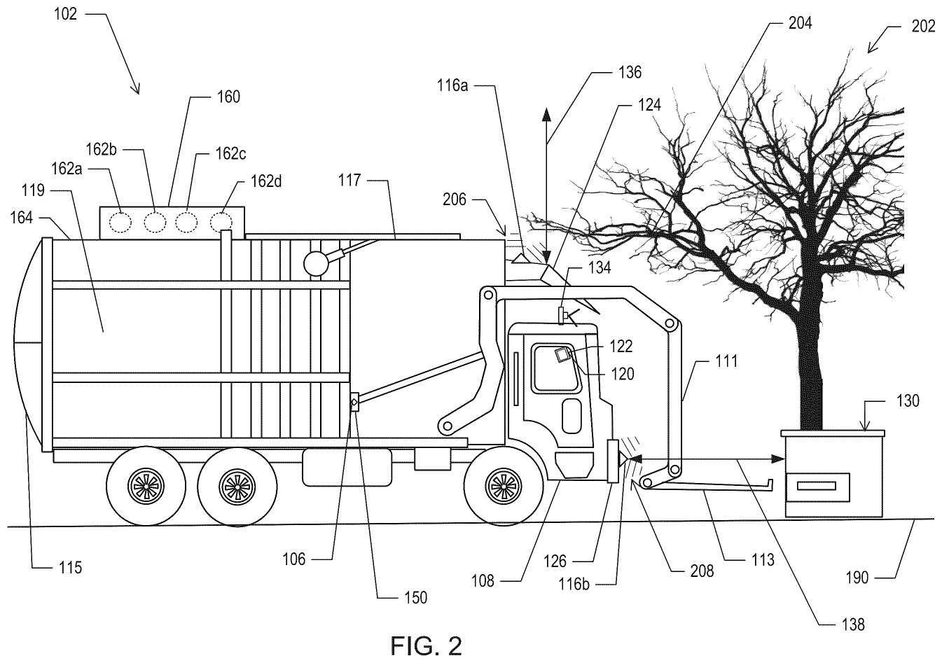

The body components 104 of the vehicle 102 can include various components that are appropriate for the particular type of vehicle 102. For example, a refuse collection vehicle may be a truck with an automated side loader (ASL). Alternatively, the vehicle may be a front-loading truck, a rear loading truck, a roll-off truck, or some other type of garbage collection vehicle. A vehicle with an ASL may include body components 104 involved in the operation of the ASL, such as an arm and/or grabbers, as well as other body components such as a pump, a tailgate, a packer, and so forth. A front-loading vehicle, such as the example shown in FIG. 2, may include body components 104 such as a pump, tailgate, packer, fork assembly, commercial grabbers, and so forth. A rear loading vehicle may include body components 104 such as a pump, blade, tipper, and so forth. A roll-off vehicle may include body components such as a pump, hoist, cable, and so forth. Body components 104 may also include other types of components that operate to bring garbage into a hopper of a truck, compress and/or arrange the garbage in the vehicle, and/or expel the garbage from the vehicle.

The vehicle 102 can include any number of body sensor devices 106 that sense body component(s) 104 and generate sensor data 110 describing the operation(s) and/or the operational state of various body components. The body sensor devices 106 are also referred to as sensor devices, or sensors. Sensors may be arranged in the body components, or in proximity to the body components, to monitor the operations of the body components. The body sensor devices 106 emit signals that include the body sensor data 110 describing the body component operations, and the signals may vary appropriately based on the particular body component being monitored. Body sensor devices 106 can be provided on the vehicle body to evaluate cycles and/or other parameters of various body components. For example, as described in further detail herein, the sensors 106 can detect and/or measure the particular position and/or operational state of body components such a lift arm, a fork assembly, and so forth.

Body sensor devices 106 can include, but are not limited to, an analog sensor, a digital sensor, a Controller Area Network (CAN) bus sensor, a magnetostrictive sensor, a radio detection and ranging (Radar) sensor, a light detection and ranging (LIDAR) sensor, a laser sensor, an ultrasonic sensor, an infrared (IR) sensor, a stereo camera sensor, a three-dimensional (3D) camera, in-cylinder sensors, or a combination thereof. In some implementations, the body sensor devices 106 may be incorporated into the various body components. Alternatively, the body sensor devices 106 may be separate from the body components.

The vehicle 102 can also include one or more a radio detection and ranging (radar) sensors 116 that can be used to detect one or more hazards proximate the vehicle 102. For example, as will be described in further detail herein, the Radar sensor(s) 116 can be used to detect low-lying objects above the vehicle 102, potholes or other damage or debris along a path travelled by the vehicle 102, or people near the vehicle 102. In some implementations, one or more body components 104 of the vehicle 102 can be controlled based on the output of the radar sensors 116.

In some implementations, the radar sensors 116 are configured to generate radar sensor data, such as a point cloud, indicating the presence of one or more objects proximate the respective radar sensors 116. The point cloud generated by the radar sensors 116 includes a discrete set of data points in a two-dimensional (2D) coordinate system. Each data point in the point clouds generated by the respective radar sensor 116 has a set of Cartesian coordinates (X, Y) and represents a single point on a surface of an object proximate the vehicle 102 detected by the respective radar sensor 116. The Cartesian coordinates of the data points in the point cloud can be used to determine the angle and distance of the detected object relative to the radar sensor 116. In particular, as will be described in further detail herein, the point clouds generated by the radar sensors 116 can be processed in order to detect, identify, and map one or more potentially hazardous objects proximate the vehicle 102, such as low-lying branches, potholes, or humans near the vehicle 102. In some implementations, point clouds are generated at a predefined time interval based on updated data received from the radar sensors 116 to create a set of point clouds, and the set of point clouds can be processed to detect objects proximate the vehicle 102. For example, a new point cloud can be generated every 30-40 milliseconds based on updated data received from the radar sensors 116, and two or more point clouds generated consecutively can be processed in combination to detect objects proximate the vehicle 102 as the vehicle 102 moves through an environment.

In some implementations, the radar sensors 116 are configured to output analog signals or digital signals indicating the presence of one or more objects proximate the respective radar sensors 116. In some implementations, the radar sensors 116 are configured to output Controller Area Network (CAN) messages to indicating the presence of one or more objects proximate the respective radar sensors 116.

In some implementations, the body sensor data 110 and radar sensor data 140 may be communicated from the body sensor devices 106 and the radar sensors 116, respectively, to an onboard computing device 112 in the vehicle 102. In some instances, the onboard computing device is an under-dash device (UDU), and may also be referred to as the Gateway. Alternatively, the device 112 may be placed in some other suitable location in or on the vehicle. The body sensor data 110 and radar sensor data 140 may be communicated from the body sensor devices 106 and the radar sensors 116, respectively, to the onboard computing device 112 over a wired connection (e.g., an internal bus) and/or over a wireless connection. In some implementations, a Society of Automotive Engineers standard J1939 bus in conformance with International Organization of Standardization (ISO) standard 11898 connects the various sensors with the onboard computing device. In some implementations, a Controller Area Network (CAN) bus connects the various the body sensor devices 106 and the Radar sensors 116 with the onboard computing device 112. For example, a CAN bus in conformance with ISO standard 11898 can connect the various sensors with the onboard computing device. In some implementations, body sensor data 110 and/or the radar sensor data 140 digitize the signals that communicate the sensor data 110, 140 before sending the signals to the onboard computing device 112, if the signals are not already in a digital format.

The analysis of the body sensor data 110 and the radar sensor data 140 can be performed at least partly by the onboard computing device 112, e.g., by processes that execute on the processor(s) 114. For example, the onboard computing device 112 can execute processes that perform an analysis of the body sensor data 110 to determine the current position of the body components 104, such as the lift arm position or the fork assembly position. In some implementations, an onboard program logic controller or an onboard mobile controller perform analysis of the body sensor data 110 to determine the current position of the body components 104. The onboard computing device 112 can execute processes that perform an analysis of the radar sensor data 140 to detect one or more hazards proximate the vehicle 102, such as low-lying tree branches, low-lying overpasses, low-lying power lines, potholes in the road, or animals or humans proximate the vehicle 102 (e.g., inside a refuse container). In some implementations, an onboard program logic controller or an onboard mobile controller perform analysis of the Radar sensor data 140 to detect hazards proximate the vehicle 102.

The onboard computing device 112 can include one or more processors 114 that provide computing capacity, data storage 166 of any suitable size and format, and network interface controller(s) 118 that facilitate communication of the onboard computing device 112 with other device(s) over one or more wired or wireless networks.

In some implementations, the vehicle 102 includes a body controller that manages and/or monitors various body components of the vehicle. The body controller of the vehicle 102 can be connected to multiple sensors in the body of the vehicle. The body controller can transmit one or more signals over the J1939 network, or other wiring on the vehicle, when the body controller senses a state change from any of the sensors. These signals from the body controller can be received by the onboard computing device 112 that is monitoring the J1939 network.

In some implementations, the onboard computing device 112 is a multi-purpose hardware platform. The device can include a under dash unit (UDU) and/or a window unit (WU) (e.g., camera) to record video and/or audio operational activities of the vehicle. The onboard computing device hardware subcomponents can include, but are not limited to, one or more of the following: a CPU, a memory or data storage unit, a CAN interface, a CAN chipset, NIC(s) such as an Ethernet port, USB port, serial port, I2c lines(s), and so forth, I/O ports, a wireless chipset, a global positioning system (GPS) chipset, a real-time clock, a micro SD card, an audio-video encoder and decoder chipset, and/or external wiring for CAN and for I/O. The device can also include temperature sensors, battery and ignition voltage sensors, motion sensors, CAN bus sensors, an accelerometer, a gyroscope, an altimeter, a GPS chipset with or without dead reckoning, and/or a digital can interface (DCI). The DCI cam hardware subcomponent can include the following: CPU, memory, can interface, can chipset, Ethernet port, USB port, serial port, I2c lines, I/O ports, a wireless chipset, a GPS chipset, a real-time clock, and external wiring for CAN and/or for I/O. In some implementations, the onboard computing device 112 is a smartphone, tablet computer, and/or other portable computing device that includes components for recording video and/or audio data, processing capacity, transceiver(s) for network communications, and/or sensors for collecting environmental data, telematics data, and so forth.

In some implementations, one or more cameras 134 can be mounted on the vehicle 102 or otherwise present on or in the vehicle 102. The camera(s) 134 each generate image data 128 that includes one or more images of a scene external to and in proximity to the vehicle 102. In some implementations, one or more cameras 134 are arranged to capture image(s) and/or video of a container 130 before, after, and/or during the operations of body components 104 to engage and empty a container 130. For example, for a front-loading vehicle, the camera(s) 134 can be arranged to image objects in front of, above, and/or behind the vehicle 102. As another example, for a side loading vehicle, the camera(s) 134 can be arranged to image objects to the side of the vehicle, such as a side that mounts the ASL to lift containers. In some implementations, the camera(s) 134 can capture video of a scene external to, internal to, and in proximity to the vehicle 102. In some implementations, the camera(s) 134 are controlled to capture image data and/or video data of a hazard detected by the radar sensors 116 coupled to the refuse collection vehicle 102.

In some implementations, the camera(s) 134 are communicably coupled to a graphical display 120 to communicate images and/or video captured by the camera(s) 134 to the graphical display 120. In some implementations, the graphical display 120 is placed within the interior of the vehicle. For example, the graphical display 120 can be placed within the cab 108 of vehicle 102 such that the images and/or video can be viewed by an operator of the vehicle 102 on a screen 122 of the graphical display 120. In some implementations, the graphical display 120 is a heads-up display that projects the images and/or video captured by the camera(s) 134 onto the windshield of the vehicle 102 for viewing by an operator of the vehicle 102. In some implementations, the images and/or video captured by the camera(s) 134 can be communicated to a graphical display 120 of the onboard computing device 112 in the vehicle 102. Images and/or video captured by the camera(s) 134 can be communicated from the sensors to the onboard computing device 112 over a wired connection (e.g., an internal bus) and/or over a wireless connection. In some implementations, a network bus (e.g., a J1939 network bus, a CAN network bus, etc.) connects the camera(s) with the onboard computing device 112. In some implementations, the camera(s) are incorporated into the various body components 104. Alternatively, the camera(s) may be separate from the body components 104.

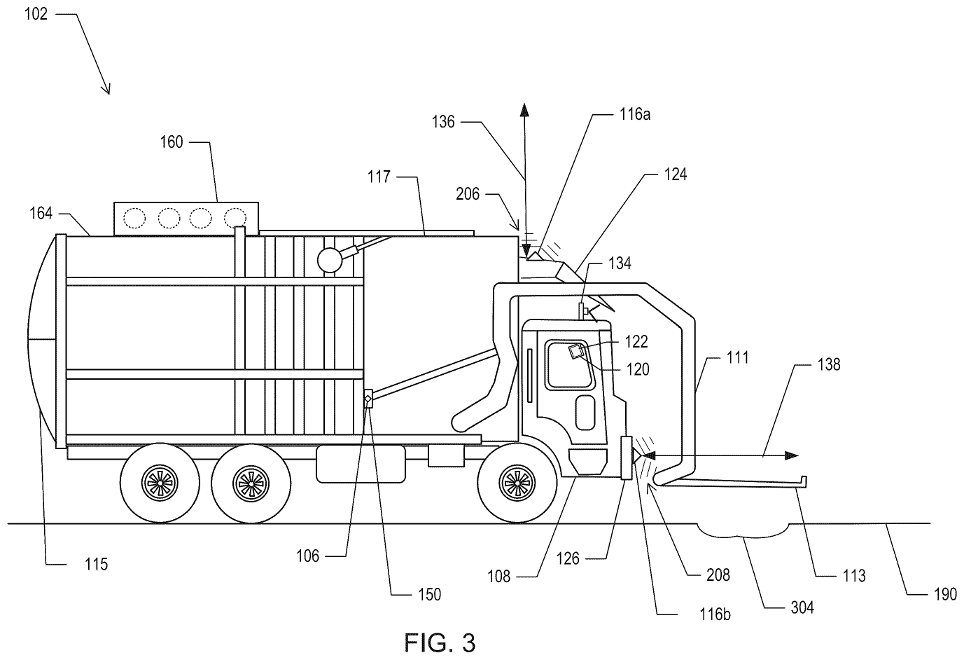

FIGS. 2 and 3 depict example schematics of a refuse collection vehicle. As shown in the example of FIGS. 2 and 3, the vehicle 102 includes various body components 104 including, but not limited to: a lift arm 111, a fork assembly 113 (also referred to herein as forks 113), a back gate or tailgate 115, and a hopper 117 to collect refuse for transportation.

Referring to FIG. 2, in some implementations, the vehicle 102 includes one or more fuel tanks 162a, 162b, 162c, 162d (collectively referred to herein as “fuel tanks 162”) that contain a fuel source for powering the chassis and/or one or more body components 104 of the vehicle 102. The fuel tanks 162 can be used to store various types of gaseous fuel including, but not limited to, compressed natural gas (“CNG”) or hydrogen. As depicted in FIGS. 2 and 3, the fuel tanks 162 can be stored in a in a pod 160 on a top surface 164 (e.g., roof) of the refuse collection vehicle 102.

One or more body sensor devices 106 can be situated to determine the state and/or detect the operations of the body components 104. In the example shown, the vehicle 102 includes a body sensor device 106 that is arranged to detect the position of the lift arm 111 and/or the forks 113. For example, the body sensor device 106 can provide data about the current position of the lift arm 111 and the forks 113 throughout a cycle to dump refuse from the container 130 into the vehicle 102. In some implementations, the body sensor device(s) 106 are located in one or more cylinders of the refuse collection vehicle 102. In some examples, body sensor device 106 is located inside a cylinder 150 used for raising the lift arm 111 and a body sensor device 106 (not shown) is located inside a cylinder used for moving the fork assembly 113 (not shown). In some implementations, body sensor device 106 is located on the outside of a housings containing the cylinder 150 coupled to the lift arm 111. In some examples, the body sensor device 106 is an in-cylinder, magnetostrictive sensor.

In some implementations, the vehicle 102 includes one or more cameras 134 oriented to capture images of the exterior of the vehicle 102. For example, the camera 134 can be configured to capture image data or video data of a scene external to and in proximity to the vehicle 102, such as in a direction of travel of the vehicle 102, behind the vehicle 102, or above the vehicle 102. As will be described in further detail herein, the image data or video data captured by the camera(s) 134 can be combined with data captured by the radar sensors 116 to detect and track hazards proximate the vehicle 102.

Referring to FIGS. 2-4, the vehicle 102 can include one or more radar sensors 116a, 116b (collectively referred to herein as radar sensors 116). For example, the vehicle 102 includes a first radar sensor 116a coupled to an upper surface of a cab protector 124 of the vehicle 102 and a second radar sensor 116b coupled to a front bumper 126 of the vehicle 102.

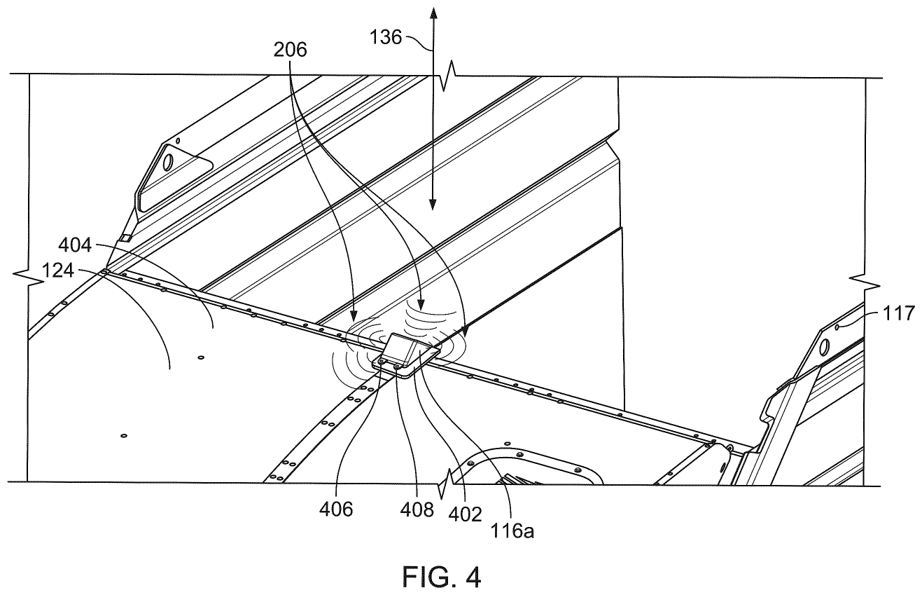

As can be seen in FIG. 4, the radar sensor 116a is attached to cab protector 124 proximate the opening of the hopper 117. In some implementations, the radar sensor 116a is attached to cab protector 124 by fixing the radar sensor 116a to a plate 402 coupled to an upper surface 404 of the cab protector 124 using one or more mechanical fasteners 406, 408 (e.g., bolts or screws). In some implementations, the plate 402 extends into and is coupled to the hopper 117 of the vehicle 102. In some implementations, the radar sensor 116a is directly attached to the upper surface 404 of the cab protector 124, for example, using welding or mechanical attachment devices, such as screws or bolts. Similarly, the radar sensor 116b can be coupled to the front bumper 126 of the vehicle 102 using a plate on the front bumper 126 or via direct attachment by welding or mechanical fasteners.

The radar sensor 116a attached to the cab protector 124 of the vehicle 102 can be used to detect low-lying objects positioned above the vehicle 102 that may cause interference with one or more body components 104 (e.g., while driving along a collection route or while servicing a refuse container 130). The radar sensor 116b attached to a front bumper 126 of the vehicle 102 can be used to detect hazards along the path the vehicle 102 is travelling, such as potholes in a road on which the vehicle 102 is currently positioned. In some implementations, the data generated by the radar sensor 116a attached to the cab protector 124 is combined with the data generated by the radar sensor 116b attached to a front bumper 126 of the vehicle 102 to determine a height relative to the road surface 190 of low-lying objects proximate the vehicle 102. The radar sensors 116 are configured to detect objects proximate the vehicle 102 under various conditions, including during refuse collection operations that cause increased levels of vibration or shock to the sensor 116 and dirty environments that would cause debris to cover the radar sensors 116.

An antenna of each of the radar sensors 116a, 116b emits radio waves 206, 208 (e.g., electromagnetic radiation) outwards from the respective radar sensor 116a, 116b. In some implementations, the radar sensors 116a, 116b are each configured to emit radio waves 206, 208 at a predefined time interval. For example, the radar sensors 116a, 116b can be configured to emit radio waves 206, 208 every 30 milliseconds.

Referring to FIGS. 2 and 3, the radio waves 206, 208 emitted by the radar sensors 116a, 116b contact and reflect off of objects that are positioned proximate the respective radar sensor 116a, 116b, and the reflected radio waves 206, 208 are detected by a receiver of the respective radar sensor 116a, 116b. For example, radio waves 206 reflected off of objects above the upper surface 404 of the cab protector 124, as well as objects in front of and above the vehicle 102 within a particular distance, are detected by a receiver of the radar sensor 116a and radio waves 208 reflected off of objects on the road surface 190 in front of the vehicle 102 are detected by a receiver of the radar sensor 116b. The reflected radio waves detected by each of the radar sensors 116a, 116b are used to form respective point clouds indicating the presence and position of one or more objects proximate the respective radar sensors 116a, 116b. The point clouds generated by the radar sensors 116a, 116b each include a discrete set of data points in a three-dimensional (3D) coordinate system, with each data point corresponding to a point on the surface of an object proximate the vehicle 102 within the detection distance 136, 138 of the respective radar sensor 116a, 116b. The coordinates corresponding to each data point in the point cloud generated by the radar sensor 116a, 116b can be used to determine the distance and angle of the respective point on the surface of the detected object relative to the radar sensor 116a, 116b.

In some implementations, the point clouds generated by the radar sensors 116a, 116b are processed by the respective radar sensor 116a, 116b in real time to detect one or more hazards proximate the vehicle 102. For example, the point cloud generated by the radar sensor 116a is processed by radar sensor 116a in real time to detect one or more hazards overlying the cab protector 124 of the vehicle 102 and objects in front of and above the vehicle 102, and the point cloud generated by the radar sensor 116b is processed by radar sensor 116b in real time to detect one or more hazards on the surface 190 along which the vehicle 102 is travelling. In some implementations, an object proximate the vehicle 102 is detected based on the size of the point cloud and/or the intensity of the points in the point cloud. For example, the radar sensors 116a, 116b can determine that there is an object within a threshold distance of the radar sensor 116a, 116b based on detecting that the point cloud generated by the radar sensor 116a, 116b is equal to or exceeds a threshold point cloud size and that point cloud includes one of more clusters of points indicating a detected object. In some implementations, clusters indicating the presence of a detected object are portions of the point cloud that have an average intensity of the points within the point cloud equal to or exceeding a threshold intensity.

In some implementations, the data generated by the radar sensors 116 is processed such that only hazards that are positioned within a particular detection distance 136, 138 relative to the respective radar sensor 116a, 116b are detected. For example, the distance between a particular object or other hazard (such as a pothole) and a radar sensor 116a, 116b can be determined based on an amount of time that has elapsed between the time that a radio wave 206, 208 was transmitted by the radar sensor 116a, 116b and the time that the reflected radio wave was received by the respective radar sensor 116a, 116b. Reflected radio waves that are received by the radar sensor 116a, 116b after a particular elapsed time that corresponds to distances greater than the respective detection distance 136, 138 can be discarded and are not included in the point cloud. As a result, the point cloud only represents objects or other hazards that are positioned within the detection distance 136, 138 relative to the respective radar sensor 116a, 116b. In some implementations, the detection distance 136 relative to the radar sensor 116a coupled to the cab protector 124 is in a range of 1 foot to 10 feet. In some implementations, the detection distance 138 relative to the radar sensor 116b coupled to the front bumper 126 is in a range of 5 feet to 20 feet. In some implementations, the detection distance 136 relative to the radar sensor 116a coupled to the cab protector 124 and the detection distance 138 relative to the radar sensor 116b coupled to the front bumper 126 are configured to enable detection of objects that are within a particular distance in front of the vehicle 102 and could result in a potential overhead collision with the vehicle 102. In some implementations, the detection distances 136, 138 relative to the respective radar sensors 116a, 116b are configured to detect potential overhead hazards that are in a range of 10 feet to 200 feet in front of the vehicle 102.

In some implementations, the detection distances 136, 138 of the radar sensors 116 are adjusted based on a current speed of travel of the vehicle 102. For example, as the speed of travel of the vehicle 102 increases, the detection distances 136, 138 of the radar sensors 116 can increase proportionally to ensure that upcoming objects that may contact the vehicle 102 are detected far enough in advance of the vehicle 102 to provide the operator of the vehicle 102 with sufficient time to avoid contact with the detected object (e.g., by stopping or re-routing the vehicle 102).

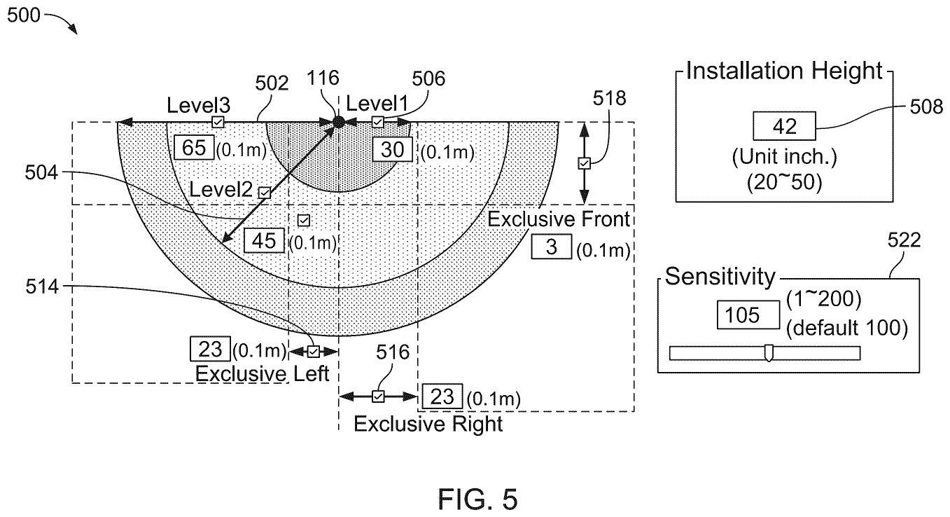

In some implementations, each radar sensor 116a, 116b can have multiple levels of detection distances indicating a different respective levels of potential risk a particular hazard presents to the vehicle 102. FIG. 5 depicts one or more settings of the radar sensors 116 of the refuse collection vehicle of FIG. 2. For example, the radar sensors 116 can each have an outer (“Level 3”) detection distance 502 beyond which hazards are not detected (e.g., detection distances 136, 138), and one or more shorter detection distances that are closer to the respective radar sensor 116, such as an intermediate (“Level 2”) detection distance 504 and an inner (“Level 1”) detection distance 506. Objects and other hazards that are detected within the intermediate detection distance 504 or the inner detection distance 506 can be prioritized as being a higher risk than hazards detected only within the outer detection distance 502 due to the closer proximity between the detected hazard and the vehicle 102 for hazards positioned within the intermediate or inner detection distances 504, 506 compared to detected objects positioned outside the intermediate or inner detection distances 504, 506.

In addition, radar sensors 116 can be configured to limit the distance to the sides (i.e., left or right) of the radar sensor 116 within which hazards can be detected. For example, as depicted in FIG. 5, a radar sensor 116 can be configured to only detect objects that are within a predefined left detection distance 514 (e.g., 2.3 meters) to the left of the radar sensor 116 and only detect objects that are within a predefined right detection distance 516 (e.g., 2.3 meters) to the right of the radar sensor 116. In some implementations, the left detection distance 514 and the right detection distance 516 for a radar sensor 116 that is configured to detect hazards behind the vehicle 102 are defined in order to prevent the detection of objects that are positioned to the side of the vehicle 102, rather than directly behind the vehicle 102, such as the sides of buildings positioned to the side of the vehicle 102. As a result, by limiting the left and right detection distances 514, 516, a radar sensor coupled to a rear of the vehicle 102 can be used to reliably identify whether an object is positioned within a potential path of travel of the vehicle 102 when the vehicle 102 is backing.

The detection distances for the radar sensors 116 can also define an excluded distance 518 within which detected objects are not identified as hazards. The excluded distance 518 for a radar sensor 116 can be defined in order to prevent falsely detecting portions of vehicle 102 proximate the radar sensor 116 as hazards. For example, in FIG. 5, an excluded distance 518 of 0.3 meters is defined for the radar sensor 116 and, as a result, portions of the vehicle or other objects positioned within 0.3 meters of radar sensor 116 in any direction are not identified as hazards when processing the signals generated by the radar sensor 116.

In addition, an installation height 520 can be identified for each of the radar sensors 116, and the installation height 520 of the radar sensor 116 can be used in determining the position of one or more potential hazards in the road proximate the vehicle 102. For example, an installation height 520 can be set for a radar sensor 116 that is coupled to a bumper of the vehicle 102 (e.g., radar sensor 116b) and the installation height 520 for the radar sensor 116 can be used to determine, based on the radar sensor signals, one or more changes in the elevation of the road surface proximate the vehicle that indicate a hazard in the road, such as a pothole proximate the vehicle 102.

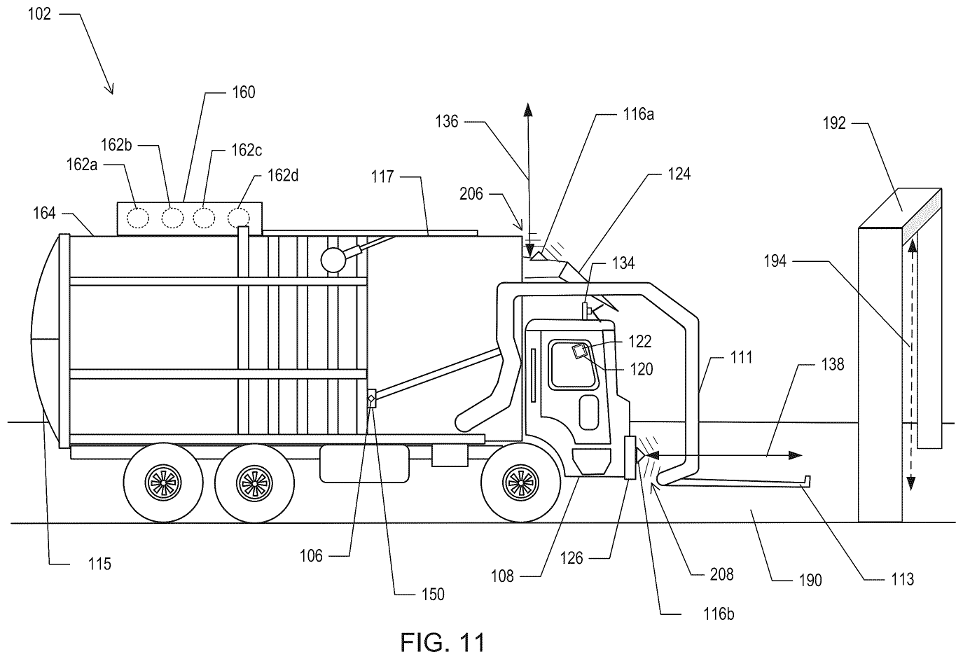

Referring to FIGS. 5 and 11, the installation height 520 of each of the radar sensors 116a, 116b can be used to determine the height of an object being approached by the vehicle 102 relative to the road surface 190 the vehicle 102 is travelling on. For example, data generated by the radar sensor 116b coupled to bumper 126 can be processed in view of the installation height of the radar sensor 116b in order to determine the vertical location of the road surface 190 relative to the location of the radar sensor 116b at a particular distance in front of the vehicle 102. Data generated by the radar sensor 116a coupled to cab protector 124 can be used to detect objects that are located at the same particular distance in front of the vehicle 102 and that are above the level of the cab protector 124 (e.g., overpass 192).

Based on the height of the object detected by the radar sensor 116a relative to the radar sensor 116a and the vertical location of the road surface 190 beneath the detected object 192 relative to the location of the radar sensor 116b, the vertical distance 194 between the road surface 190 and the detected object 192 (also referred to herein as “clearance height 194”) can be determined. For example, based on an amount of time that has elapsed between the time that a radio wave 206 was transmitted by the radar sensor 116a and the time that the reflected radio wave was received by the radar sensor 116a, the vertical distance between the object 192 and the radar sensor 116a can be determined. Similarly, based on an amount of time that has elapsed between the time that a radio wave 208 was transmitted by the radar sensor 116b and the time that the reflected radio wave was received by the radar sensor 116b, the vertical distance between the road surface 190 beneath the object 192 and the radar sensor 116b can be determined. Because the installation height of each of the radar sensors 116a, 116b is known, the vertical difference between the radar sensor 116a and radar sensor 116b is also known. The clearance height 194 of the detected object 192 can therefore be calculated based on adding the detected vertical distance between the object 192 and the radar sensor 116a, the detected vertical distance between the road surface 190 beneath the object 192 and the radar sensor 116b, and the vertical distance between the two radar sensors 116a, 116b.

The radar sensors 116 can also each have a predefined sensitivity 522. In some implementations, each of the radar sensors 116 coupled to the vehicle 102 have the same sensitivity 522. In some implementations, one or more of the radar sensors 116 coupled to the vehicle 102 have a different sensitivity 522. In some implementations, the sensitivity 522 of the radar sensors 116 is in a range between 1 and 200.

In some implementations, based on processing the point cloud generated by the radar sensors 116a, 116b and detecting one or more hazards proximate the vehicle 102, the radar sensors 116a, 116b can transmit a CAN message to the onboard computing device 112 of the vehicle 102 indicating the presence of the detected hazards. For example, the radar sensor 116a can transmit a CAN message to the onboard computing device 112 of the vehicle 102 indicating detected hazards overlying the vehicle 102 within the detection distance 136 of the radar sensor 116a. Similarly, the radar sensor 116b can transmit a CAN message to the onboard computing device 112 of the vehicle 102 indicating detected hazards in front of the vehicle 102 within the detection distance 138 of the radar sensor 116b. In some implementations, the radar sensors 116a, 116b transmit a CAN message to the onboard computing device 112 of the vehicle 102 indicating an angular location relative to the respective radar sensor 116a, 116b for each of the detected hazards. In some implementations, the angular location of the detected hazards relative to the respective radar sensor 116a, 116b is provided as (X, Y) Cartesian coordinates. In some implementations, in response to detecting a hazard proximate the vehicle, the radar sensors 116a, 116b can transmit a CAN message to the onboard computing device 112 as a digital (e.g., discrete) output, for example, a positive indication that a hazard located is within the respective detection distance 136, 138 of the vehicle 102.

In response to receiving a signal from one or more of the radar sensors 116a, 116b indicating that the vehicle 102 is proximate a hazard, the onboard computing device 112 can perform one or more actions to record and/or to respond to the detected hazard. In some implementations, the onboard computing device controls one or more body components 104 of the vehicle 102 in order to prevent or mitigate contact between the vehicle and the detected hazard.

For example, in response to receiving a signal from the radar sensor 116a coupled to the cab protector 124 indicating that an object (e.g., a tree branch, an overpass, or a power line) is positioned above the vehicle 102 within the detection distance 136, the onboard computing device 112 can control the lift arm 111 of the vehicle to prevent the lift arm from being lifted above a height that would result in contact between the forks 113 or lift arm 111 and the object detected by the radar sensor 116a. In some implementations, the onboard computing device 112 receives signals from one or more body sensor devices 106 indicating the current position of the lift arm 111 and the forks 113, and prevents the lift arm 111 from being raised when the height of the lift arm 111 or the forks 113 indicated by the signals from the body sensor device(s) 106 is within a threshold distance of the object detected by the radar sensor 116a in order to prevent collision between the lift arm 111 and/or forks 113 with the detected hazard.

In some implementations, in response to receiving a signal from the radar sensor 116b coupled to the front bumper 126 indicating that a hazard is present in front of the vehicle 102 within the detection distance 138, such as a pothole in the road surface 190 or debris on the road surface 190, the onboard computing device 112 can control the vehicle 102 to change its position on the road surface 190 to avoid contact between the vehicle 102 and the detected hazard. In some implementations, in response to receiving a signal from the radar sensor 116b coupled to the front bumper 126 indicating that a pothole is within the detection distance 138 of the vehicle 102, the onboard computing device 112 can control the vehicle 102 to reduce its speed of travel below a threshold speed in order to mitigate damage caused by the vehicle 102 driving through the detected pothole.

In some implementations, the data generated by one or more of the radar sensors 116a, 116b can be used to determine whether the fuel pod 160 is likely to contact a low-lying object (e.g., overpass, tree branch, power line, etc.) that the vehicle 102 is approaching. The radar sensors 116a, 116b can improve the safety of the vehicle by detecting objects the vehicle 102 is approaching that are at risk of contacting the fuel pod 160.

In response to determining that an upcoming overhead object (e.g., low-lying tree branch, a low-lying power line, or a low-lying overpass) detected by the radar sensor 116a is likely to contact the fuel pod 160 and/or the roof 164 of the vehicle 102, the onboard computing device 112 can cause a visual alert and/or an audible alert to be generated to alert the driver of the vehicle 102 that an upcoming overhead object is likely to contact the fuel pod 160 and/or the roof 164 of the vehicle 102 if the vehicle passes underneath the detected object. In some implementations, in response to determining that an upcoming overhead object detected by the radar sensor 116a is likely to contact the fuel pod 160 and/or the roof 164 of the vehicle 102, the onboard computing device 112 can control the vehicle 102 to reduce its speed of travel below a threshold speed in order to provide the driver with sufficient time to re-route the vehicle to avoid collision with the overhead object. In some implementations, in response to determining that an upcoming overhead object detected by the radar sensor 116a is likely to contact the fuel pod 160 and/or the roof 164 of the vehicle 102, the onboard computing device 112 can control the vehicle 102 to automatically re-route the vehicle to avoid collision with the object.

In some implementations, the objection detections are tracked over time using signals received from the radar sensors 116, and one or more components of the vehicle are controlled based on the object tracking. For example, in some implementations, the onboard computing device 112 locks the position of the lift arm 111 and the forks 113 in response to detecting an overhead object a threshold number of times (e.g., 2 detections, 3 detections, etc.) within a particular time interval (e.g., within 10 milliseconds, 100 milliseconds, 1 second, etc.). The overhead object can be continued to be tracked based on the radar sensor signals and the position of the lift arm 111 and the forks 113 remains locked until the number of detections of an overhead object within the particular time interval is below the threshold. In some implementations, the onboard computing device 112 controls the vehicle 102 to reduce its speed of travel below a threshold speed in response to detecting a pothole a threshold number of times (e.g., 2 detections, 3 detections, etc.) within a particular time interval (e.g., within 10 milliseconds, 100 milliseconds, 1 second, etc.). The pothole can be continued to be tracked based on the radar sensor signals and the speed of the vehicle 102 can continue to be restricted to a threshold speed until the number of detections of a pothole within the particular time interval is below the threshold.

In some implementations, in response to receiving a signal from one or more of the radar sensors 116a, 116b indicating that the vehicle 102 is proximate a hazard, the onboard computing device 112 can cause a visual alert and/or an audible alert to be generated that alerts an operator of the vehicle 102 to the presence of the detected hazard. In some implementations, a visual alert is displayed on the screen 122 of display device 120 inside the cab 108 of the vehicle 102 in response to receiving a signal from a radar sensor 116a, 116b indicating the presence of a hazard proximate the vehicle. In some implementations, the onboard computing device 112 controls one or more body components 104 of the vehicle 102 based on an operator of the vehicle 102 acknowledging, or failing to acknowledge, an alert generated in response to detecting a hazard proximate the vehicle. For example, in response to receiving a signal from one or more of the radar sensors 116a, 116b indicating that the vehicle 102 is proximate a hazard, the onboard computing device 112 can cause a visual alert to be displayed within the cab 108 of the vehicle 102 (e.g., on the screen 122 of display device 120), and the onboard computing device can prevent the position of one or more body components 104 of the vehicle (e.g., the lift arm 111) from being adjusted until the operator of the vehicle has provided an input to acknowledging the displayed alert. In some implementations, in response to determining that an upcoming overhead object (e.g., low-lying tree branch, a low-lying power line, or a low-lying overpass) is likely to contact the fuel pod 160 and/or the roof 164 of the vehicle 102, the onboard computing device 112 can cause a visual alert and/or an audible alert to be generated to alert the driver of the vehicle 102 that an upcoming overhead object is likely to contact the fuel pod 160 and/or the roof 164 of the vehicle 102 if the vehicle passes underneath the detected object.

In some implementations, in response to receiving a signal from one or more of the radar sensors 116a, 116b indicating that the vehicle 102 is proximate a hazard, the onboard computing device 112 can store information related to the detected hazard, including, but not limited to, a size of the detected hazard, a type of object corresponding to the detected hazard (e.g., a low-lying tree branch, a low-lying power line, a low-lying overpass, or a pothole), GPS coordinates corresponding to the location of the detected hazard, image data and/or video data of the detected hazard, the detected clearance height 194 of an overhead object, and a timestamp corresponding to the time that the hazard was detected by the radar sensor 116. The data related to the detected hazard can be stored (e.g., in a database) by the onboard computing device 112 or by a remote computing device (i.e., a computing device located remotely from the vehicle 102).

In some implementations, in response to receiving a signal from one or more of the radar sensors 116a, 116b indicating that the vehicle 102 is proximate a hazard, the onboard computing device 112 causes one or more cameras 134 coupled to the vehicle 102 to capture image and/or video data of the hazard detected by the radar sensor 116a, 116b. The image data and/or video data captured by the one or more cameras 134 can include a timestamp, and the data captured by the camera(s) 134 can be identified as corresponding to a detected hazard based on a signal received from a radar sensor 116a, 116b. The onboard computing device 112 or a remote computing device can process the data captured by the camera(s) 134 and the signals received from the radar sensors 116a, 116b to determine image and/or video data corresponding to a detected hazard, and store the corresponding image and/or video data together with other data related to the detected hazard.

In some implementations, the GPS coordinates of a hazard detected by a radar sensor 116a, 116b can be determined and stored together with other data related to the hazard detected by the radar sensor 116a, 116b. In some implementations, the GPS coordinates of the detected hazard are determined based on the GPS coordinates of the vehicle 102 at the time the signal corresponding to the respective hazard is generated by the radar sensor 116a, 116b. In some implementations, the GPS coordinates of the detected hazard are determined based on the GPS coordinates of the vehicle 102 at the time the signal corresponding to the respective hazard is received by the onboard computing device 112 from the respective radar sensor 116a, 116b. The onboard computing device 112 or a remote computing device can determine the GPS location of the detected hazard and store the GPS location with other data related to the detected hazard.

In some implementations, the size of the hazard and the type of hazard detected by a radar sensor 116a, 116b is determined based on processing the point cloud generated by the radar sensor 116a, 116b to detect one or more characteristics of the point cloud corresponding to a particular object hazard type. For example, the point cloud generated by a radar sensor 116a, 116b can be processed (e.g., by the radar sensor 116a, 116b, by the onboard computing device 112, or by a remote computing device) using machine learning based processing techniques to determine the type of object (e.g., a low-lying tree branch, a low-lying power line, a low-lying overpass, a pothole, etc.) corresponding to the respective hazard detected by the radar sensor 116a, 116b. In some implementations, image data and/or video data captured by the camera(s) 134 of the vehicle 102 can be used to determine the size of the hazard and the type of object corresponding to the hazard detected by a radar sensor 116a, 116b. For example, image data and/or video data captured by the camera(s) 134 of the vehicle 102 can be processed (e.g., by the onboard computing device 112 or by a remote computing device) using machine learning based image processing techniques to determine the size of the hazard and the type of object (e.g., a low-lying tree branch, a low-lying power line, a low-lying overpass, a pothole, etc.) corresponding to the respective hazard.

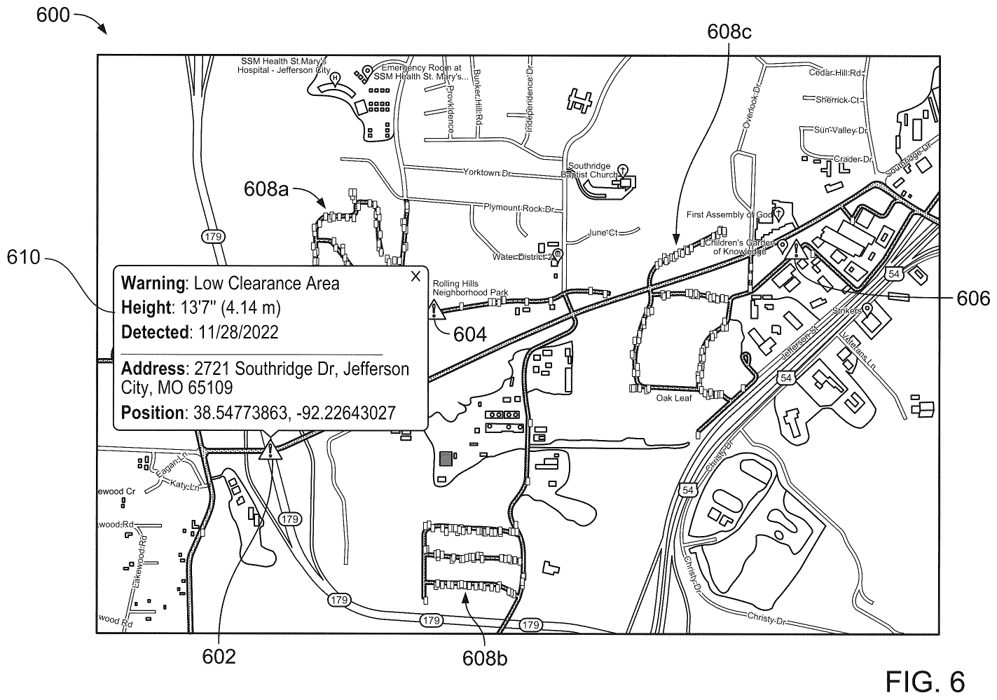

In some implementations, the hazards detected by the radar sensors 116a, 116b can be recorded in a hazards map 600. For example, based on the signals received from the radar sensors 116a, 116b, a processor (e.g., onboard computing device 112 or a remote computing device) can generate a map 600 that includes hazard warning map elements 602, 604, 606 that each indicate the location of a respective hazard detected by a radar sensor (e.g., radar sensors 116a, 116b) of a refuse collection vehicle (e.g., vehicle 102). As can be seen in FIG. 6, the hazard warning map elements 602, 604, 606 are overlaid on a topographical map at a GPS location of the corresponding hazard detected by a radar sensor on a refuse collection vehicle. The hazard map 600 can also include map elements 608a, 608b, 608c indicating service events performed by a refuse collection vehicle, such as collection of refuse from refuse containers. In some implementations, the hazard map 600 is generated based on signals received from radar sensors positioned on multiple refuse collection vehicles.

The hazard map 600 can be displayed to a user (e.g., an operator of the vehicle 102) on a display device, such as the screen 122 of the graphical display 120 positioned within the cab 108 of the vehicle 102. An operator of the vehicle 102 can review the hazard map 600 to determine, and potentially avoid, one or more previously detected hazards in advance of or while travelling along a refuse collection route. In some implementations, the hazard map 600 is transmitted (e.g., by the onboard computing device 112 or by a remote computing device) to one or more entities associated with the location of a detected hazards included in the hazard map 600. For example, in response to detecting a low-lying tree branch hazard located at a particular property, a hazard map with a hazard warning indicator corresponding to the detected tree branch hazard can be transmitted to a computing device of an entity associated with the property (e.g., the owner of the respective property).

As depicted in FIG. 6, in response to a user selecting a particular hazard warning map element 602, an informational map element 610 is displayed on the map 600 proximate the selected hazard warning map element 602. The informational map element 610 displays one or more data items related to the hazard represented by the respective hazard warning map element 602. For example, as depicted in FIG. 6, the informational map element 610 for the selected hazard warning map element 602 displays the type of hazard detected at the respective location (e.g., a “Low Clearance” hazard), the clearance height of the hazard, relevant location information for the detected hazard (e.g., an address corresponding to the hazard and GPS coordinates corresponding to the hazard), and the date the hazard was detected by a radar sensor. In some implementations, the informational map element 610 for a respective hazard warning map element 602 can display one or more other items of data related to the hazard including, but not limited to, image data related to the detected hazard, video data related to the detected hazard, a size of the detected hazard, and a time that the hazard was detected by a radar sensor.

In some implementations, a refuse collection vehicle (e.g., vehicle 102) can be controlled based on one or more hazards that are identified in a previously-generated hazard map 600. For example, the speed of the vehicle 102 can automatically be limited to a threshold speed when the vehicle 102 is travelling in an area that the hazard map 600 indicates as having road hazards. In addition, the position of the lift arm 111 and the forks 113 can be automatically locked when the vehicle 102 is travelling in an area that the hazard map 600 indicates as having overhead hazards. The vehicle 102 can be re-routed to avoid an area that the hazard map 600 indicates as having overhead hazards with a clearance height that is less than or equal to the height of the vehicle 102.

An example process for detecting a hazard overlying the vehicle 102, such as a low lying tree branch, overpass, or power line, will now be described with reference to FIGS. 1, 2, and 6. As depicted in FIG. 2, a refuse container 130 to be serviced by the vehicle 102 is positioned underneath a tree 202 with a low-lying tree branch 204 that would contact the lift arm 111 and the forks 113 of the vehicle 102 when the lift arm 111 is raised to dump the contents of the refuse container 130 into the hopper 117. As the vehicle 102 approaches the refuse container 130, the radar sensor 116a coupled to the cab protector 124 emits radio waves 206 outwards a detection distance 136 away from the radar sensor 116a, and the radio waves 206 contact and are reflected off of objects within a volume around the radar sensor 116a defined by the detection distance 136, including the tree branch 204. Radio waves 206 emitted by the radar sensor 116a that are reflected off of the tree branch 204 are detected by a receiver of the radar sensor 116a, and the radar sensor 116a generates a point cloud based on the reflected radio waves 206 detected by a receiver of the radar sensor 116a. As previously described, the radar sensor 116a can process the point cloud to detect that a hazard 204 is overlying the vehicle 102 at the current location of the vehicle 102. In some implementations, the point cloud can be processed to determine that the hazard 204 overlying the vehicle is a tree branch. As previously discussed, in addition to detecting low-lying tree branches, the radar sensor 116a can be used to detect other types of overlying hazards, such as low-lying power lines or overpasses.

In response to detecting the tree branch 204, the radar sensor 116a transmits a CAN message to the onboard computing device 112 of the vehicle 102 indicating the presence of the tree branch hazard 204 detected by the radar sensor 116a. In some implementations, the CAN message transmitted by the radar sensor 116a includes an angular location of the tree branch hazard 204 relative to the radar sensor 116a. In some implementations, the CAN message transmitted by the radar sensor 116a includes a digital (e.g., discrete) output that indicates that an object is overlying the vehicle 102 within the detection distance 136 of the radar sensor 116a.

In response to receiving a signal from the radar sensor 116a that a tree branch 204 is positioned above the vehicle 102 within the detection distance 136 of the radar sensor 116a, the onboard computing device 112 can prevent the lift arm 111 of the vehicle from being lifted above a threshold height that would result in contact between forks 113 or lift arms 111 and the tree branch 204 detected by the radar sensor 116a. For example, based on the signal received from the radar sensor 116a, the onboard computing device 112 can determine a height of the tree branch 204 and can prevent the lift arm 111 and forks 113 from being raised above the detected height of the tree branch 204. In some implementations, the onboard computing device 112 receives signals from one or more body sensor devices 106 indicating the current position of the lift arm 111 and the forks 113, and prevents the lift arm 111 from being raised when the height of the lift arm 111 or the forks 113 indicated by the signals received from the body sensor device(s) 106 is within a threshold distance of the height of the tree branch 204 detected by the radar sensor 116a. In some implementations, in response to receiving a signal from the radar sensor 116a indicating the tree branch hazard 204, the onboard computing device 112 can cause a visual alert and/or an audible alert to be generated indicating the presence of the tree branch 204 detected by the radar sensor 116a. For example, in response to receiving a signal from the radar sensor 116a indicating that a tree branch 204 is positioned above the vehicle 102, the onboard computing device 112 can cause a visual alert to be displayed within the cab 108 of the vehicle 102 (e.g., on the screen 122 of display device 120), and can prevent the lift arm 111 from being raised above a threshold height until the operator of the vehicle has provided an input acknowledging the displayed alert.

In response to the radar sensor 116a detecting the tree branch hazard 204, data related to the detected tree branch hazard 204 can be captured and recorded by the onboard computing device 112. For example, in response to receiving the signal from the radar sensor 116a indicating the tree branch hazard 204, the onboard computing device 112 can control a camera 134 coupled to the vehicle 102 to capture image data and/or video data of the tree branch 204, and the data captured by the camera 134 can be stored together with other data related to the detected tree branch hazard 204. In addition, the location of the detected tree branch hazard 204 can be recorded in a hazard map (e.g., hazard map 600 of FIG. 6) by displaying a hazard warning map element (e.g., map element 602 of FIG. 6) at a location corresponding to the GPS location of the vehicle 102 at the time the radar sensor signal corresponding to the tree branch 204 was generated by the radar sensor 116a or was received by the vehicle 102. As previously discussed, the hazard map can also be used to display additional data related to the detected tree branch hazard 204, including, but not limited to, the size of the tree branch 204, the type of object corresponding to the hazard 204 (i.e., tree branch), GPS coordinates corresponding to the location of the tree branch hazard 204, image data and/or video data of the tree branch hazard 204, and a timestamp corresponding to the time that the tree branch hazard 204 that was detected by the radar sensor 116a.

An example process for detecting a potential collision between the fuel pod 160 of the vehicle 102 and an overhead hazard that the vehicle 102 is approaching, such as a low lying tree branch, overpass, or power line, will now be described with reference to FIGS. 1, 6, and 11. As depicted in FIG. 11, a vehicle 102 is travelling along a road surface 190 and approaching an overpass 192 extending over the road surface 190. As the vehicle 102 approaches the overpass 192, the radar sensor 116a coupled to the cab protector 124 emits radio waves 206 away from the radar sensor 116a and the radio waves 206 contact and are reflected off of objects within a volume around the radar sensor 116a defined by the detection distance 136, including the overpass 192. Radio waves 206 emitted by the radar sensor 116a that are reflected off of the overpass 192 are detected by a receiver of the radar sensor 116a, and the radar sensor 116a generates a point cloud based on the reflected radio waves 206 detected by a receiver of the radar sensor 116a. As previously described, the radar sensor 116a can process the point cloud to detect that the vehicle 102 is approaching a potential overhead hazard 192. In some implementations, the point cloud can be processed to determine that the hazard 192 is an overpass.

As previously discussed, the data generated by the radar sensors 116a, 116b can also be used to determine a height of the approaching overhead hazard 192. For example, data generated by the radar sensors 116a, 116b can be processed to determine a height of the overpass 192 relative to the road surface 190, and the detected height of the overpass 192 can be used to determine whether any portion of the vehicle 102, such as the fuel pod 160 and/or the roof 164 of the vehicle 102, is at risk of contacting the overpass 192. For example, the onboard computing device 112 can compare the detected height of the overpass 192 with the overall height of the vehicle, including the fuel pod 160, to determine whether the height of the overpass 192 is less than or substantially equal to the overall height of the vehicle 102 or that the height of the overpass is greater than the overall height of the vehicle 102 by less than a threshold amount. In response to determining that the height of the overpass 192 is less than or substantially equal to the overall height of the vehicle 102 or that the height of the overpass is greater than the overall height of the vehicle 102 by less than a threshold amount, the onboard computing device 112 determines that the fuel pod 160 and/or roof 164 of the vehicle 102 is at risk of contacting the upcoming overpass if the vehicle 102 travels underneath the overpass 192.

In response to determining that the fuel pod 160 and/or roof 164 of the vehicle 102 is at risk of contacting the approaching overpass if the vehicle 102 travels underneath the overpass 129, the onboard computing device 112 can cause a visual alert and/or an audible alert to be generated indicating that the vehicle 102 is at risk of coming into contact with an upcoming overhead object. For example, in response to determining, based on a signal from the radar sensor 116a, the height of an upcoming overpass 192 and determining that the vehicle 102 is at risk of contacting the upcoming overpass 192 if the vehicle 102 travels underneath the overpass 192, the onboard computing device 112 can cause a visual alert to be displayed within the cab 108 of the vehicle 102 (e.g., on the screen 122 of display device 120) alerting the driver of the vehicle 102 of the potential collision and suggesting that the driver of the vehicle 102 change the route to avoid collision with the detected overhead hazard 192. In some implementations, in response determining that the vehicle 102 is at risk of contacting the upcoming overpass 192 if the vehicle 102 travels underneath the overpass 192, the onboard computing device 112 can generate a visual and/or audible alert to notify the driver of the detected height of the overpass 192 relative to the road surface 190 (the clearance height 194 of the overpass 192).

In some implementations, determining that the vehicle 102 is at risk of contacting the upcoming overpass 192 if the vehicle 102 travels underneath the overpass 192, the onboard computing device 112 can cause the vehicle 102 to automatically reduce its speed of travel below a threshold speed in order to provide the driver with sufficient time to avoid collision between the vehicle 102 and the overpass 192. In some implementations, for example, if the vehicle 102 is being driven autonomously or semi-autonomously, the onboard computing device 112 can automatically re-route the vehicle 102 to prevent the vehicle 102 from passing underneath the overpass 192 in response to detecting that the vehicle 102 is at risk of contacting the upcoming overpass 192 if the vehicle 102 travels underneath the overpass 192.

In response to the radar sensor 116a detecting the overpass hazard 192, data related to the detected overpass hazard 192 can be captured and recorded by the onboard computing device 112. For example, in response to receiving the signal from the radar sensor 116a indicating the overhead hazard 192, the onboard computing device 112 can control a camera 134 coupled to the vehicle 102 to capture image data and/or video data of the overpass 192, and the data captured by the camera 134 can be stored together with other data related to the detected overhead hazard 192, such as the detected height of the overhead hazard 192 relative to the road surface 190 (the clearance height 194 of the overhead hazard 192). In addition, the location of the detected overhead hazard 192 can be recorded in a hazard map (e.g., hazard map 600 of FIG. 6) by displaying a hazard warning map element (e.g., map element 602 of FIG. 6) at a location corresponding to the GPS location of the vehicle 102 at the time the radar sensor signal corresponding to the overhead hazard 192 was generated by the radar sensor 116a or was received by the vehicle 102. As previously discussed, the hazard map can also be used to display additional data related to the detected overhead hazard 192, including, but not limited to, the height 194 of the hazard 192 relative to the road surface 190, the type of object corresponding to the hazard 192 (i.e., overpass), GPS coordinates corresponding to the location of the hazard 192, image data and/or video data of the hazard 192, and a timestamp corresponding to the time that the hazard 192 that was detected by the radar sensor 116a.

An example process for detecting a hazard along a road surface 190 in front of the vehicle 102, such as debris on the road surface 190 or a pothole in the road surface 190, will now be described with reference to FIGS. 1, 3, and 6. As depicted in FIG. 3, while driving along a refuse collection route, a vehicle 102 may approach a pothole 304 or other surface defect in the road 190 that would potentially cause damage to vehicle 102. As the vehicle 102 travels along the road surface 190, the radar sensor 116b coupled to the front bumper 126 emits radio waves 208 outwards a detection distance 138 away from the radar sensor 116b. The radio waves 208 emitted by the radar sensor 116b contact and are reflected off of objects within a volume around the radar sensor 116b defined by the detection distance 138, including the pothole 304. Radio waves 208 emitted by the radar sensor 116a that are reflected off the pothole 304 in the road surface 190 ahead of the vehicle are detected by a receiver of the radar sensor 116b, and the radar sensor 116b generates a point cloud based on the reflected radio waves 208 detected by the radar sensor 116b. As previously described, the radar sensor 116b can process the point cloud to detect that a hazard 304 is positioned in front of the vehicle 102. In some implementations, the point cloud can be processed to determine that the hazard 304 is a pothole 304 in the road surface 190 in front of the vehicle 102. For example, a pothole 304 proximate the vehicle 102 can be detected based on receiving signals from the radar sensor 116b indicating that the distance between the radar sensor 116b and a particular area of the road surface corresponding to the pothole 304 is larger than the detected distance between the radar sensor 116b and the road surface surrounding the pothole 304 or an expected distance between the radar sensor 116b and the road surface (e.g., based on the installation height of the radar sensor 116).

In response to detecting the pothole 304 in front of the vehicle 102, the radar sensor 116b transmits a CAN message to the onboard computing device 112 of the vehicle 102 indicating the presence of the pothole hazard 304 detected within the detection distance 138 of the radar sensor 116b. In some implementations, the CAN message transmitted by the radar sensor 116b includes an angular location of the pothole 304 relative to the radar sensor 116b. In some implementations, the CAN message transmitted by the radar sensor 116b includes a digital (e.g., discrete) output that indicates that a hazard is located within the detection distance 138 of the radar sensor 116b.

In response to receiving a signal from the radar sensor 116b coupled indicating that a pothole 304 is present within the detection distance 138 in front of the vehicle 102, the onboard computing device 112 can control one or more actions of the vehicle 102 to avoid the detected pothole. For example, in response to receiving a signal from the radar sensor 116b indicating that a pothole 304 is within the detection distance 138 of the vehicle 102, the onboard computing device 112 can cause the vehicle 102 to reduce its speed of travel below a threshold speed in order to mitigate damage caused by the vehicle 102 driving over the pothole 304. In some implementations, in response to receiving a signal from the radar sensor 116b indicating that a pothole 304 is within the detection distance 138 of the vehicle 102, the onboard computing device 112 can control the vehicle 102 to change its position on the road surface 190 in order to avoid contact between the vehicle 102 and the detected hazard.

In some implementations, in response to receiving a signal from the radar sensor 116b indicating the pothole hazard 304, the onboard computing device 112 can cause a visual alert and/or an audible alert to be generated indicating the presence of the detected pothole 304. For example, in response to receiving a signal from the radar sensor 116b indicating the pothole hazard 304, the onboard computing device 112 can cause a visual alert to be displayed within the cab 108 of the vehicle 102 (e.g., on the screen 122 of display device 120) to warn the driver of the vehicle of the detected pothole 304 and suggest that the driver of the vehicle reduce the speed at which the vehicle 102 is travelling and/or change the position of the vehicle on the road 190 to avoid contact with the pothole 304.

In some implementations, in response to the radar sensor 116b detecting the pothole hazard 304, data related to the detected pothole hazard 304 can be captured and recorded. For example, in response to receiving the signal from the radar sensor 116b indicating a pothole hazard 304, the onboard computing device 112 can control the camera 134 coupled to the vehicle 102 to capture image data and/or video data of the pothole 304, and the data captured by the camera 134 can be stored together with other data related to the detected pothole 304. In addition, the location of the detected pothole 304 can be recorded in a hazard map (e.g., hazard map 600 of FIG. 6) by displaying a hazard warning map element (e.g., map element 604 of FIG. 6) at a location corresponding to the GPS location of the vehicle 102 at the time the radar sensor signal corresponding to the pothole 304 was generated by the radar sensor 116b or was received by the vehicle 102. As previously discussed, the hazard map can also be used to display additional data related to the detected hazard, including, but not limited to, the size of the pothole 304, the type of object corresponding to the detected hazard 304 (i.e., pothole), GPS coordinates corresponding to the location of the pothole 304, image data and/or video data of the pothole 304, and a timestamp corresponding to the time that the pothole 304 was detected by the radar sensor 116b.

In addition to detecting hazards proximate to the vehicle 102 that could result in damage to the vehicle 102, the radar sensor 116b can be used to detect humans and animals that are proximate the vehicle 102, but that are difficult for the driver of the vehicle 102 to visualize while operating the vehicle 102. For example, a person or animal walking behind the vehicle 102 could be detected using a radar sensor 116 coupled to a rear portion of the vehicle 102, such as the tailgate 115 or the rear bumper of the vehicle 102. Similarly, a person or animal positioned in front of the vehicle coupled be detected by a radar sensor coupled to the cab 108 of the vehicle 102, such as radar sensor 116b. In some implementations, in response to receiving a signal from a radar sensor 116b that a person or animal is present within the detection distance of the radar sensor 116b in front of the vehicle 102, the onboard computing device 112 can cause a visual alert and/or an audible alert to be generated indicating the presence of a person within the detection distance of the radar sensor 116b. For example, in response to receiving a signal from the radar sensor 116b that a person is present within the detection distance of the radar sensor 116b coupled to the front bumper 126 of the vehicle 102, the onboard computing device 112 can cause a visual alert to be displayed within the cab 108 of the vehicle 102 (e.g., on the screen 122 of display device 120), and onboard computing device 112 can prevent the lift arm 111 from being raised until the operator of the vehicle has provided an input to acknowledging the displayed alert. In some implementations, in response to receiving a signal from a radar sensor coupled to a rear portion of the vehicle 102 (such as the tailgate 115 or a rear bumper) indicating that a person is present within the detection distance of the radar sensor, the onboard computing device 112 can cause a visual alert to be displayed within the cab 108 of the vehicle 102 (e.g., on the screen 122 of display device 120), and onboard computing device 112 can prevent the vehicle from being operated in reverse and/or prevent movement of the tailgate 115.

While certain embodiments have been described, other embodiments are possible.

For example, while the vehicle 102 has been described as including two radar sensors 116, other numbers of radar sensors are possible (e.g., 1, 3, 4, 5, etc.). In addition, while the radar sensors 116a, 116b have been described as being coupled to a cab protector 124 of the vehicle 102 and a front bumper 126 of the vehicle, respectively, radar sensors can be attached to other portions of the vehicle 102, including, but not limited to, a surface of the cab 108 of the vehicle 102 (e.g., the roof of the cab 108), the lift arm 111 of the vehicle 102, a tailgate 115 of the vehicle 102, a rear bumper of the vehicle 102, to the sides of the storage body 119 of the vehicle 102, on the roof of the storage body 119 of the vehicle 102, or to the sides of the cab 108 of the vehicle 102. For example, in some implementations, the radar sensor 116a is coupled to a roof of the storage body of the vehicle 102 (e.g., on the roof proximate the hopper 117). In some implementations, the vehicle includes a radar sensor coupled to a rear bumper of the vehicle 102 or the tailgate 115 of the vehicle in order to detect hazards that are located behind the refuse collection vehicle 102, and the onboard computing device 112 provides an operator of the vehicle an indication of the detected hazard behind the vehicle and/or prevents the vehicle from being driven in reverse in response to receiving a signal from the radar sensor coupled to the tailgate 115 or rear bumper indicating that a hazard is behind the vehicle 102. In some implementations, the vehicle 102 includes one or more radar sensors that are mounted to the frame of the vehicle 102 and are pointed downwards in order to detect pothole or other road hazards. In some implementations, one or more radar sensors are coupled to one or more sides of the storage body 119 and/or the cab 108 of the vehicle 102 in order to detect objects positioned to the side of the vehicle 102.

In addition, while the point cloud used to detect objects proximate the vehicle 102 has been described as being generated based data received from one or more radar sensors 116, in some implementations, other types of sensors can be used to generate the point cloud. For example, one or more LiDAR sensors can be used to generate a point cloud to detect one or more objects proximate the vehicle 102.

While the point cloud has been described as being processed by the respective radar sensor 116a, 116b that generated the point cloud, in some implementations, the point cloud is processed by another processor. For example, in some implementations, the point clouds generated by the radar sensors 116a, 116b are processed by the onboard computing device 112 or by a computing device that is remote from the vehicle 102.

Further, while the point cloud generated by the radar sensors 116 has been described including a discrete set of data points in a two-dimensional (2D) coordinate system, in some implementations, the point cloud generated by the radar sensor includes data points in a three-dimensional (3D) coordinate system, and each data point in the point cloud generated by the radar sensors 116 has a set of Cartesian coordinates (X, Y, Z) that represent a single point on a surface of an object proximate the vehicle 102 detected by the respective radar sensor 116.

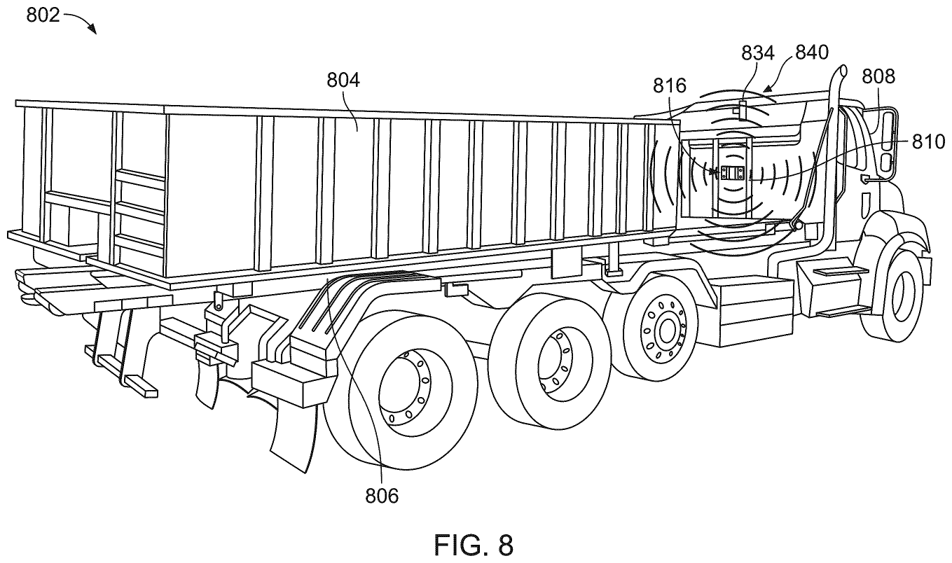

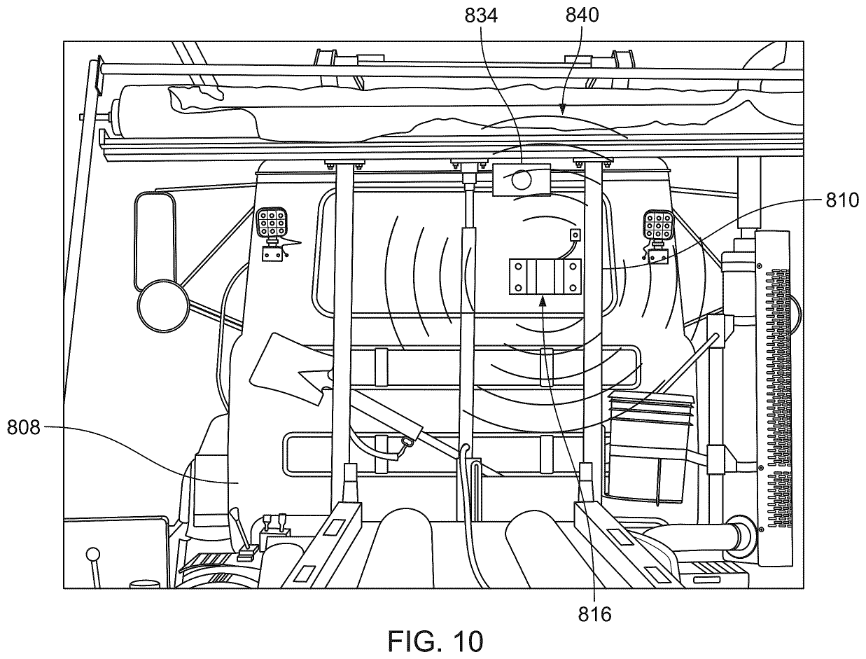

Further, while the radar sensors 116 have been described as being used to detect hazards proximate a refuse collection vehicle 102, in some implementation, radar sensors 116 can be used to detect the presence of roll-off container on a roll-off truck (also referred to herein as roll-off vehicle). FIGS. 8-10 depict a roll-off vehicle 802 with a radar sensor 816 for detecting a roll-off container 804 positioned on the bed 806 of the roll-off vehicle 802. The radar sensor 816 is coupled to a portion of the roll-off vehicle 802 proximate the cab 808 of the vehicle 802 and is oriented towards the bed 806 of the vehicle 802. For example, as depicted in FIG. 10, the radar sensor 816 can be coupled to a tarp bracket 810 of the roll-off vehicle 802.

The structure and function of the radar sensor 816 is substantially similar to that of the radar sensors 116 depicted in FIGS. 1-5. For example, similar to radar sensors 116 of FIGS. 1-5, the radar sensor 816 on the roll-off vehicle 802 is configured to generate radar sensor data, such as a point cloud, indicating the presence of one or more objects proximate the radar sensor 816, such as a roll-off container positioned on the bed 806 of the vehicle 802. In some implementations, the radar sensor 816 is configured to output analog signals or digital signals indicating the presence of one or more objects proximate the radar sensor 816. In some implementations, the radar sensor 816 is configured to output Controller Area Network (CAN) messages to indicating the presence of one or more objects proximate the respective radar sensors 116.

Based on the radar signals 840 generated by the radar sensor 816, a determination can be made regarding whether a roll-off container 804 is present on the bed 806 of the vehicle 802. For example, the presence a roll-off container 804 positioned on the bed 806 of the vehicle 802 can be detected based on determining that the point cloud generated by the radar sensor 816 is equal to or exceeds a threshold point cloud size and that point cloud includes one of more clusters of points corresponding to a roll-off container. In some implementations, clusters indicating the presence of a roll-off container are portions of the point cloud that have an average intensity of the points within the point cloud equal to or exceeding a threshold intensity

In some implementations, in order to detect the presence of a roll-off container 804 on the bed 806, the radar signals 840 generated by the radar sensor 816 are processed to determine whether an object is detected within a particular detection distance from the radar sensor 816. In some implementations, the detection distance for the radar sensor 816 is between 0.1 meters and 3 meters from the radar sensor 816. In some implementations, the detection distance for the radar sensor 816 is configured to enable the radar sensor 816 to sense various sizes of roll-off containers loaded on the bed 806 of the vehicle 802. In some implementations, the detection distance for the radar sensor 816 is 3 meters from the radar sensor 816. By limiting the detection distance of the radar sensor 816, the radar sensor 816 can be used to reliably detect the presence of a roll-off container 804 positioned on the bed 806 of the vehicle 802 while minimizing false detections based on other objects positioned proximate the vehicle 802.

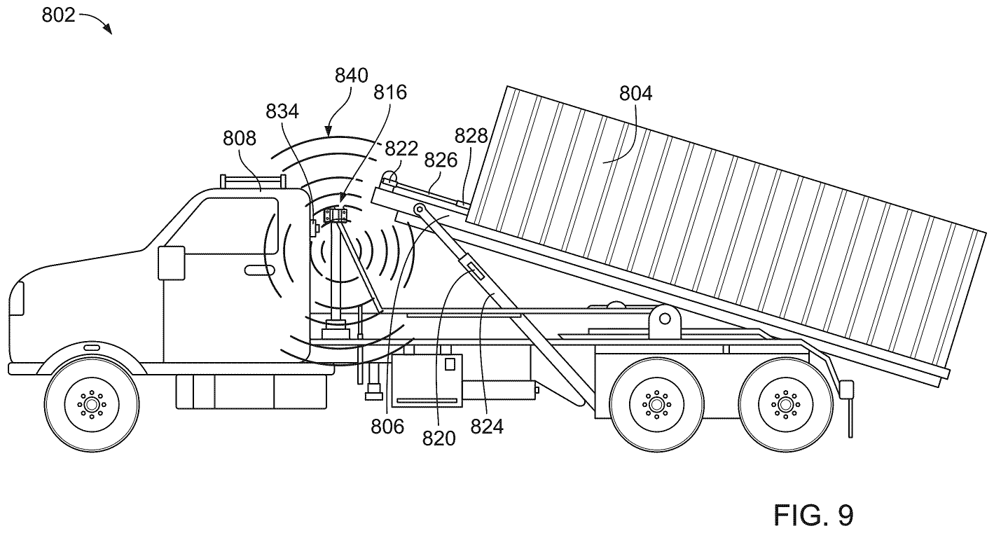

In some implementations, point clouds are generated at a predefined time interval based on updated data received from the radar sensors 816 to create a set of point clouds, and the set of point clouds can be processed to detect objects proximate the vehicle 802. Referring to FIG. 9, in some implementations, one or more point clouds are generated based on data received from the radar sensor 816 at a time corresponding to a roll-off container service event, as detected by one or more body sensors 820, 822 on the vehicle 802. For example, the vehicle 802 can include one or more body sensors 820 coupled to one or more of the hydraulic cylinders 824 used to raise and lower the bed 806, and the one or more body sensors 820 are configured to detect extension and retraction of the hydraulic cylinders 824 during unloading or loading of a roll-off container 804. In some implementations, the vehicle 802 can include a body sensor 822 coupled to a hoist 826 of the vehicle 802 in order to detect extension or retraction of the hoist 826 during unloading or loading of a roll-off container 804. Based on receiving a signal from one or more body sensors 820, 822, the radar signals 840 generated by the radar sensor 816 can be processed to determine whether a roll-off container 804 has been loaded onto the vehicle 802 or unloaded from the vehicle 802, for example, based on whether a container 804 is presently detected on the bed 806 of the vehicle 802 by the radar sensor 816.

In some implementations, the signals generated by the radar sensor 816 can be used to determine whether a roll-off container loaded on the vehicle 802 is full or empty. For example, in response to detecting the presence of a roll-off container 804 on the bed 806, the radar signals 840 can be further processed to determine a distance between the bed 806 and the surface that the vehicle 802 is positioned on (e.g., the road surface). Based on the detected distance between the bed 806 and the road surface, the amount of refuse contained within the roll-off container 804 can be determined. In some implementations, if the distance between the bed 806 and the road surface determined based on the radar signals 840 is less than a threshold distance, the roll-off container 804 can be identified as being full. In some implementations, if the distance between the bed 806 and the road surface determined based on the radar signals 840 is above a threshold distance, the roll-off container 804 can be identified as being empty.

The distance between the bed 806 and the surface that the vehicle 802 is positioned on determined based on the radar signal 840 can also be used to determine whether a roll-off container 804 is loaded on the vehicle 802. For example, if the distance between the bed 806 and the road surface, as determined based on the radar signals 840, is reduced (e.g., by 1 inch to 3 inches) compared to a baseline distance corresponding to a vehicle 802 without a roll-off container positioned on the bed 806, a roll-off container 804 can be detected as being loaded on the bed 806 of the vehicle 802.

In some implementations, the hoist 826 of the vehicle 802 is coupled to a load cell 828, and the data generated by the load cell 828 can be combined with the radar signals 840 to determine the amount of refuse contained within a roll-off container 804 positioned on the bed 806 of the vehicle 802. In some implementation, if the force detected by the load cell 828 is above a threshold force, the roll-off container 804 can be determined as being full. In some implementation, if the force detected by the load cell 828 is below a threshold force, the roll-off container 804 can be determined as being empty. In some implementations, a scale can be coupled to or incorporated into the bed 806 of the vehicle 802, and the amount of refuse contained within a roll-off container 804 positioned on the bed 806 can be determined based on signals received from the scale coupled to or incorporated into the bed 806.

In some implementations, in response to receiving a signal from the radar sensor 816 indicating that a roll-off container 804 has been loaded onto or unloaded from the roll-off vehicle 802, an onboard computing device of the vehicle 802 (e.g., similar to onboard computing device 112 of FIG. 1) causes one or more cameras 834 coupled to the vehicle 802 to capture image and/or video data of the roll-off container 804. For example, in response to detecting that a roll-off container 804 has been loaded onto the bed 806 of the vehicle 802 based on the radar sensor signals 840, a rear-facing camera 834 coupled to the vehicle 802 can be controlled to capture an image of the roll-off container 804 positioned on the vehicle 802. Similarly, in response to detecting that a roll-off container 804 has been unloaded from the vehicle 802 based on the radar sensor signals 840, a rear-facing camera 834 or a side-facing camera coupled to the vehicle 802 can be controlled to capture an image of the roll-off container 804 at the location that the roll-off container has been unloaded from the vehicle 802. The image data and/or video data captured by the one or more cameras 834 can include a timestamp, and the data captured by the camera(s) 834 can be identified as corresponding to a corresponding roll-off container service event that is detected based on signals received from the radar sensor 816. In some implementations, an onboard computing device or a remote computing device can process the data captured by the camera(s) 834 and the signals received from the radar sensor 816 to determine image and/or video data corresponding to a roll-off container service event, and store the corresponding image and/or video data together with other data related to the service event.

In some implementations, the GPS coordinates of a roll-off container service event performed by the vehicle 802 can be determined and stored together with other data related to the roll-off container service event detected by the radar sensor 816. In some implementations, the GPS coordinates of the detected roll-off container service event are determined based on the GPS coordinates of the vehicle 802 at the time that a signal corresponding to the respective service event is generated by the radar sensor 816. In some implementations, the GPS coordinates of the detected service event are determined based on the GPS coordinates of the vehicle 802 at the time a signal corresponding to radar signal 840 corresponding the respective service event is received by an onboard computing device of the vehicle 802 from the radar sensor 816. An onboard computing device of the vehicle 802 or a remote computing device can determine the GPS location of the detected roll-off container service event and store the GPS location with other data related to the detected service event.

In addition, the location of the detected roll-off container service event can be recorded in a map by displaying a service event map element (e.g., service event elements 608a, 608b, 608c in hazard map 600 of FIG. 6) at a location corresponding to the GPS location of the vehicle 802 at the time the radar sensor signal corresponding to the roll-off container service event was generated by the radar sensor 816 or was received by a computing device, such as an onboard computing device of the vehicle 802. The map can also be used to display additional data related to the detected roll-off container service event, including, but not limited to, whether the service event was a loading versus an unloading event, the weight of the roll-off container, whether the roll-off container was full or empty, GPS coordinates corresponding to the location of the service event, image data and/or video data of the roll-off container, and a timestamp corresponding to the time that service event was detected by the radar sensor 816.

In some implementations, data related to the detected roll-off container service event can be stored (e.g., in a database) by an onboard computing device (e.g., similar to onboard computing device 112 of FIG. 1) or by a remote computing device (i.e., a computing device located remotely from the vehicle 802). The data related to a detected roll-off container service event can include, but is not limited to, whether the service event was a loading versus an unloading event, a detected weight of the roll-off container (e.g., as received from one or more of the body sensor 820, 822 or a scale on the bed 806 of the vehicle 802), whether the roll-off container was full or empty, GPS coordinates corresponding to the location of the service event, image data and/or video data of the roll-off container, and a timestamp corresponding to the time that service event was detected by the radar sensor 816. As previously discussed, the data related to roll-off container service events detected based on the radar signals 840 can be used to generate a map indicating the location of each of the detected service events. The stored roll-off container service event data can be used to modify routes of travel performed by roll-off vehicles in order to optimize efficiency of the roll-off container service events performed by the roll-off container vehicle. For example, the stored roll-off container service event data can be used to determine the amount of time spent performing each detected roll-off container service event, and the route performed by the roll-off container vehicle can be modified to reduce the amount of time between roll-off container service events. In addition, the data related to the detected roll-off container service events can be used for service verification and billing purposes. For example, a customer related to a particular roll-off container service event detected by the radar sensor 816 could be automatically charged for the detected service event. In some implementations, a customer can access the stored roll-off container service event data in order to track the service events that have been performed for one or more roll-off containers 804 associated with the customer.

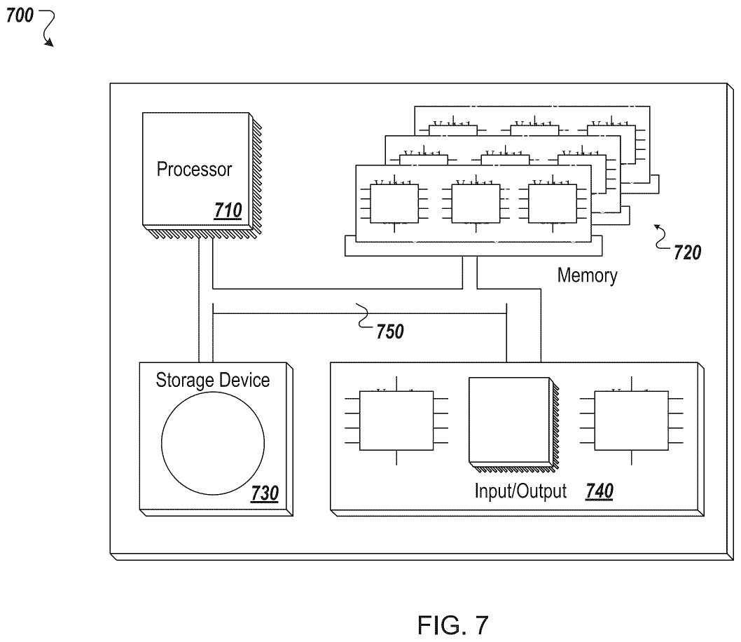

FIG. 7 depicts an example computing system, according to implementations of the present disclosure. The system 700 may be used for any of the operations described with respect to the various implementations discussed herein. For example, the system 700 may be included, at least in part, in one or more of the onboard computing device 112, and/or other computing device(s) or system(s) described herein. The system 700 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 700 includes a processor 710, a memory 720, a storage device 730, and an input/output device 740. Each of the components 710, 720, 730, and 740 are interconnected using a system bus 540. The processor 710 is capable of processing instructions for execution within the system 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a joystick. In some implementations, the input/output device 740 includes a display unit for displaying graphical user interfaces. For example in some implementations, the input/output device 740 is a display device that includes one or more buttons and/or a touchscreen for receiving input from a user. In some implementations, the input/output device 740 includes a keyboard and/or a pointing device. In some implementations, the input/output device 740 is located within a cab of a refuse collection vehicle (e.g., within cab 108 of vehicle 102). For example, the input/output device 740 can be attached to or incorporated within a dashboard inside the cab of a refuse collection vehicle.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A system comprising:
a refuse collection vehicle, comprising:
a chassis; and
one or more body components; and
at least one radar sensor coupled to a portion of the refuse collection vehicle, the at least one radar sensor configured to detect one or more hazards positioned within a detection distance of the at least one radar sensor.

2. The system of claim 1, wherein the one or more hazards positioned within a detection distance of the at least one radar sensor comprise one or more objects overlying the refuse collection vehicle.

3. The system of claim 2, wherein:
the refuse collection vehicle includes a cab protector; and
the at least one radar sensor is coupled to the cab protector.

4. The system of claim 1, wherein the one or more hazards positioned within a detection distance of the at least one radar sensor comprise one or more hazards along a surface on which the refuse collection vehicle is positioned.

5. The system of claim 4, wherein the refuse collection vehicle includes a front bumper; and the at least one radar sensor is coupled to the front bumper.

6. The system of claim 1, wherein the one or more hazards positioned within a detection distance of the at least one radar sensor comprise an object in front of the refuse collection vehicle and that could result in a potential overhead collision with the refuse collection vehicle.

7. The system of claim 6, wherein the refuse collection vehicle comprises one or more fuel tanks coupled to a roof of the refuse collection vehicle.

8. The system of claim 1, wherein the refuse collection vehicle further comprises a camera configured to capture image data or video data of the one or more hazards.

9. The system of claim 1, wherein the system further comprises a computing device, and the at least one radar sensor is configured to transmit, to the computing device, a signal indicating the one or more hazards.

10. A method of operating a refuse collection vehicle, the method comprising:
detecting, using at least one radar sensor coupled to the refuse collection vehicle, a hazard positioned within a detection distance of the at least one radar sensor;
transmitting, from the at least one radar sensor to a computing device, a signal indicating the hazard detected by the at least one radar sensor; and
in response to receiving the signal, controlling the refuse collection vehicle to prevent damage to the refuse collection vehicle resulting from contact between the hazard and the refuse collection vehicle.

11. The method of claim 10, wherein the hazard comprises an object overlying the refuse collection vehicle.

12. The method of claim 11, wherein controlling the refuse collection vehicle to prevent damage to the refuse collection vehicle resulting from contact between the hazard and the refuse collection vehicle comprises preventing a lift arm of the refuse collection vehicle from being raised above a threshold height.

13. The method of claim 10, wherein the hazard comprises a hazard along a road surface on which the refuse collection vehicle is positioned.

14. The method of claim 10, wherein the hazard comprises an object in front of the refuse collection vehicle and that could result in a potential overhead collision with the refuse collection vehicle.

15. The method of claim 14, wherein detecting the hazard comprises:
detecting, based on data generated by the at least one radar sensor, a clearance height of the object; and
determining that the clearance height of the object is less than an overall height of the refuse collection vehicle.

16. The method of claim 10, wherein detecting, the hazard positioned within the detection distance of the at least one radar sensor comprises:
generating, by the radar sensor, a point cloud; and
processing, by the radar sensor, the point cloud to detect the hazard.

17. The method of claim 10, further comprising in response to receiving the signal, causing a camera coupled to the refuse collection vehicle to capture image data or video data of the hazard.

18. The method of claim 10, further comprising generating a map comprising a map element indicating a location of the hazard detected by the radar sensor.

19. The method of claim 10, further comprising in response to receiving the signal, generating a visual alert or an audible alert.

20. A system comprising:
refuse collection vehicle, comprising:
a chassis comprising a bed; and
at least one radar sensor coupled to a portion of the refuse collection vehicle, the at least one radar sensor configured to detect a roll-off container positioned on the bed of the refuse collection vehicle.
